(19) United States
(12) Patent Application Publication
(10) Pub. No.: US 2024/0370708 A1
(43) Pub. Date: Nov. 7, 2024

(54) DISTRIBUTED GENERATIVE ARTIFICIAL INTELLIGENCE FOR IMPROVED USER WORKFLOW

(71) Applicants: Kartik Nadipuram Raghavan, Los Altos, CA (US); John David Risher, San Francisco, CA (US)

(72) Inventors: Kartik Nadipuram Raghavan, Los Altos, CA (US); John David Risher, San Francisco, CA (US)

(21) Appl. No.: 18/313,069

(22) Filed: May 5, 2023

(51) Int. Cl. G06N 3/0475; G06N 3/045

(52) U.S. Cl. CPC G06N 3/0475; G06N 3/045

(57) ABSTRACT

Systems/techniques that facilitate distributed generative artificial intelligence (AI) for improved user workflow are provided. In various embodiments, a client device can generate a prompt-output history by sequentially performing drafting iterations. In various aspects, a drafting iteration can include querying a user of the client device for a respective input prompt (which may be an edited version of a previous input prompt provided by the user during a previous drafting iteration) and synthesizing a respective coarse output via execution of a first generative AI model hosted by the client device. In various instances, the client device can instruct a server device to synthesize a fine output based on at least part of the prompt-output history, via execution of a second generative AI model hosted by the server device. In various cases, the first generative AI model can exhibit lower fidelity but quicker inferencing time than the second generative AI model.

### TECHNICAL FIELD

The subject disclosure relates generally to generative artificial intelligence, and more specifically to distributed generative artificial intelligence for improved user workflow.

### BACKGROUND

Generative artificial intelligence (AI) is ushering in a paradigm shift regarding how users create content. Before the advent of generative AI, a user would manually create content from scratch, beginning with a blank page and being in full control of the creative process. After the advent of generative AI, however, the user no longer begins with a blank page and is no longer in full control of the creative process. Instead, the user feeds raw source material into a prompt box of a generative AI model, and the generative AI model synthesizes content based on that raw source material. In order to achieve whatever specific content is envisioned or desired by the user, the user might iterate with the generative AI model, inputting progressively updated or edited raw source materials until the specific content that is desired is obtained.

According to various existing techniques, the generative AI model can be hosted on a server device, and the user can wirelessly or remotely interface with the server device via a client device. Unfortunately, if the user desires to iterate with the generative AI model, such existing techniques can consume excessive amounts of time, due to a slow inferencing speed of the generative AI model and due to accumulation of communication overhead between the server device and the client device. Such excessive consumption of time can frustrate, halt, or otherwise interrupt the user's train of thought or workflow, which can be undesirable.

According to various other existing techniques, the generative AI model can instead be downloaded from the server device onto the client device. Such other existing techniques can reduce communication overhead between the server device and the client device. However, such other existing techniques can nevertheless consume excessive amounts of time, due to the slow inferencing speed of the generative AI model. Again, such excessive consumption of time can negatively influence the user's train of thought or workflow, which can be undesirable.

Thus, systems or techniques that can address one or more of these technical problems can be considered as desirable.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate distributed generative artificial intelligence for improved user workflow are described.

According to one or more embodiments, a client device is provided. The client device can comprise a non-transitory computer-readable memory that can store computer-executable components. The client device can further comprise a processor that can be operably coupled to the non-transitory computer-readable memory and that can execute the computer-executable components stored in the non-transitory computer-readable memory. In various embodiments, the computer-executable components can comprise a drafting component that can generate a prompt-output history comprising a set of input prompts and a set of coarse outputs. In various aspects, the drafting component can facilitate this by sequentially performing drafting iterations. In various instances, during a drafting iteration, the drafting component can: query a user of the client device for a respective one of the set of input prompts, which can be an edited version of a previous input prompt that was provided by the user during a previous drafting iteration; and synthesize a respective one of the set of coarse outputs, by executing, on the respective one of the set of input prompts, a first generative artificial intelligence model that is hosted by the client device. In various cases, the computer-executable components can comprise a finalization component that can instruct a server device to synthesize a fine output by executing, on at least part of the prompt-output history, a second generative artificial intelligence model hosted by the server device. In various aspects, the first generative artificial intelligence model can exhibit lower fidelity but quicker inferencing time than the second generative artificial intelligence model.

According to one or more embodiments, a server device is provided. The server device can comprise a non-transitory computer-readable memory that can store computer-executable components. The server device can further comprise a processor that can be operably coupled to the non-transitory computer-readable memory and that can execute the computer-executable components stored in the non-transitory computer-readable memory. In various embodiments, the computer-executable components can comprise an access component that can access, from a client device operated by a user, at least part of a prompt-output history. In various aspects, the prompt-output history can comprise a set of input prompts that are sequentially provided by the user throughout a set of drafting iterations. In various instances, some of the set of input prompts can be edited versions of others of the set of input prompts. In various cases, the prompt-output history can comprise a set of coarse outputs that are respectively synthesized, throughout the set of drafting iterations and based on the set of input prompts, by a first generative artificial intelligence model hosted on the client device. In various aspects, the computer-executable components can comprise a model component that can synthesize a fine output, by executing, on the at least part of the prompt-output history, a second generative artificial intelligence model hosted by the server device. In various instances, the second generative artificial intelligence model can exhibit slower inferencing time but higher fidelity than the first generative artificial intelligence model.

According to various embodiments, the above-described systems can be implemented as computer-implemented methods or as non-transitory computer program products.

### DESCRIPTION OF THE DRAWINGS

FIG. 1 illustrates a block diagram of an example, non-limiting system that facilitates distributed generative artificial intelligence for improved user workflow in accordance with one or more embodiments described herein.

FIG. 2 illustrates a block diagram of an example, non-limiting client device that facilitates distributed generative artificial intelligence for improved user workflow in accordance with one or more embodiments described herein.

FIG. 3 illustrates a block diagram of an example, non-limiting client device including a prompt-output history that facilitates distributed generative artificial intelligence for improved user workflow in accordance with one or more embodiments described herein.

FIG. 4 illustrates an example, non-limiting block diagram showing a prompt-output history in accordance with one or more embodiments described herein.

FIG. 5 illustrates an example, non-limiting block diagram showing how a prompt-output history can be generated in accordance with one or more embodiments described herein.

FIG. 6 illustrates a block diagram of an example, non-limiting client device including suggested prompt edits, coarse previews, and editorial controls that facilitates distributed generative artificial intelligence for improved user workflow in accordance with one or more embodiments described herein.

FIG. 7 illustrates a block diagram of an example, non-limiting client device including a finalization instruction that facilitates distributed generative artificial intelligence for improved user workflow in accordance with one or more embodiments described herein.

FIG. 8 illustrates a block diagram of an example, non-limiting server device that facilitates distributed generative artificial intelligence for improved user workflow in accordance with one or more embodiments described herein.

FIG. 9 illustrates a block diagram of an example, non-limiting server device including a finalization instruction that facilitates distributed generative artificial intelligence for improved user workflow in accordance with one or more embodiments described herein.

FIG. 10 illustrates a block diagram of an example, non-limiting server device including a fine generative output that facilitates distributed generative artificial intelligence for improved user workflow in accordance with one or more embodiments described herein.

FIG. 11 illustrates an example, non-limiting block diagram showing how a fine generative output can be generated in accordance with one or more embodiments described herein.

FIGS. 12-16 illustrate example, non-limiting prompts and generative outputs in accordance with one or more embodiments described herein.

FIGS. 17-18 illustrate flow diagrams of example, non-limiting computer-implemented methods that facilitate distributed generative artificial intelligence for improved user workflow in accordance with one or more embodiments described herein.

FIG. 19 illustrates an example, non-limiting communication diagram pertaining to distributed generative artificial intelligence for improved user workflow in accordance with one or more embodiments described herein.

FIG. 20 illustrates a block diagram of an example, non-limiting system in which a server device interfaces with a plurality of client devices to facilitate distributed generative artificial intelligence for improved user workflow in accordance with one or more embodiments described herein.

FIG. 21 illustrates a flow diagram of an example, non-limiting computer-implemented method that facilitates client-side distributed generative artificial intelligence for improved user workflow in accordance with one or more embodiments described herein.

FIG. 22 illustrates a flow diagram of an example, non-limiting computer-implemented method that facilitates server-side distributed generative artificial intelligence for improved user workflow in accordance with one or more embodiments described herein.

FIG. 23 illustrates a block diagram of an example, non-limiting operating environment in which one or more embodiments described herein can be facilitated.

FIG. 24 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Generative artificial intelligence (AI) can be considered as ushering in a paradigm shift regarding how users (e.g., artists) create content (e.g., create finished, polished, full-length, or otherwise non-rough-draft artistic content, such as paintings, videos, musical scores, poems, stories, or essays). Before the advent of generative AI, a user would manually create content from scratch. Indeed, the user would begin with a blank page (e.g., a blank piece of paper or canvas, a blank word processing document, a blank photo-editing file, a blank video-editing file, a blank music-editing file), and the user would be in full control of the creative process (e.g., the user would manually craft the content word by word, line by line, stroke by stroke, frame by frame, or note by note). After the advent of generative AI, however, the user no longer begins with a blank page and is no longer in full control of the creative process. Instead, the user feeds raw source material (e.g., short text strings, rough sketches, raw images) into a prompt box of a generative AI model, and the generative AI model synthesizes content based on that raw source material. In other words, the generative AI model automatically outputs seemingly-finished content (or otherwise a close approximation of finished content) that is substantively rooted in or otherwise related to the raw source material.

For example, suppose that the generative AI model is configured to perform a text-to-image transformation. In such case, the raw source material can be a short textual string provided by the user, and the content synthesized by the generative AI model can be an image that visually illustrates whatever is described in that short textual string. As another example, suppose that the generative AI model is instead configured to perform a text-and-image-to-video transformation. In such case, the raw source material can be both a short textual string and an image provided by the user, and the content synthesized by the generative AI model can be a video clip that visually illustrates an object or character depicted in that image performing an activity described in that short textual string.

In any case, the user can envision a particular content that they desire to be achieved. In order to achieve that particular content, the user can iterate with the generative AI model, inputting progressively updated or edited raw source materials until that particular content is synthesized by the generative AI model. In other words, the user can incrementally change the raw source material, thereby causing the generative AI model to synthesize incrementally changed content, and the user can repeatedly do this until the user determines that the most recent content synthesized by the generative AI model is sufficiently similar to that which the use envisions or desires. In this way, generative AI can be considered as transforming users from content creators that are fully in control of the creative process into content editors that influence the creative process in symbiotic cooperation with generative AI.

According to various existing techniques, the generative AI model can be hosted on a server device, and the user can wirelessly or remotely interface with the server device via a client device. In such cases, the user can input raw source material into the client device, the client device can electronically forward (e.g., over the internet or any other network connection) such raw source material to the server device, the server device can synthesize content based on the raw source material by executing the generative AI model, and the client device can receive the synthesized content from the server device and can visually render the synthesized content to the user.

Unfortunately, if the user iterates with the generative AI model, such existing techniques can consume excessive amounts of time. Indeed, during a single iteration, such existing techniques consume time in at least two ways: time spent on electronic communication between the client device and the server device; and time spent during actual execution of the generative AI model. Regarding the first way in which time is spent, a non-zero amount of time is consumed when the client device transmits raw source material to the server device, and another non-zero amount of time is consumed when the server device transmits synthesized content back to the client device. Depending upon the electronic connections between the client device and the server device, such non-zero amounts of time can be on the order of several seconds. Now consider the second way in which time is spent. Existing techniques often train the generative AI model to exhibit as high a fidelity as possible. That is, existing techniques attempt to teach the generative AI model how to synthesize content having maximum perceptible quality (e.g., maximum visual quality images or videos, maximum aural quality music, maximum literary quality text or essays). In exchange for such high fidelity, the generative AI model often exhibits exceedingly slow inferencing speed. In fact, it is not unusual for a generative AI model to consume 30 seconds, 45 seconds, or even more than a minute during execution. Therefore, when various existing techniques are implemented, slow inferencing speed and communication overhead during a single iteration between the user and the generative Al model can force the user to wait on the order of an entire minute to obtain synthesized content, and such time spent waiting can multiplicatively accumulate with each additional iteration that the user performs.

According to various other existing techniques, rather than transmitting the raw source material to and receiving the synthesized content from the server device, the client device can instead download a local copy of the generative AI model from the server device. In such cases, the user can input raw source material into the client device, the client device can synthesize content based on the raw source material by executing its local copy of the generative AI model, and the client device can visually render the synthesized content to the user.

Such other existing techniques can reduce the communication overhead between the server device and the client device. After all, such other existing techniques do not spend time during each iteration ferrying the raw source material and the synthesized content back and forth between the client device and the server device. However, such other existing techniques can nevertheless consume excessive amounts of time when the user iterates with the generative AI model. After all, the local copy of the generative AI model can still have a slow inferencing speed (e.g., can require 30 seconds, 45 seconds, or even over a minute for one execution). Thus, when such other existing techniques are implemented, slow inferencing speed during a single iteration between the user and the generative AI model can force the user to wait excessively long to obtain synthesized content, and such time spent waiting can still multiplicatively accumulate with each additional iteration that the user performs.

So, existing techniques for facilitating generative AI consume too much time (e.g., due to slow inferencing speed or communication overhead), especially when a user engages in multiple content synthesis iterations. Such excessive consumption of time can negatively influence the user's workflow. Indeed, such existing techniques force the user to continually start and stop their work in a halting, jarring, or otherwise frustrating manner. Such repeated starting, stopping, and waiting can interrupt or otherwise distract the user's train of thought, which can lead to suboptimal content synthesis. This can be considered as undesirable.

Thus, systems or techniques that can address one or more of these technical problems can be considered as desirable.

Various embodiments described herein can address one or more of these technical problems. One or more embodiments described herein can include systems, computer-implemented methods, apparatus, or computer program products that can facilitate distributed generative artificial intelligence for improved user workflow. In other words, the inventors of various embodiments described herein devised various techniques for facilitating content synthesis via generative AI, which techniques can reduce or eliminate interruptions in the train of thought or workflow of the user.

In particular, various embodiments described herein can involve hosting a generative AI model on the client device and hosting another generative AI model on the server device. The server-side generative AI model can be configured or otherwise trained for high fidelity inferencing. Thus, the server-side generative AI model can synthesize content that has high visual, aural, or literary quality, at the expense of experiencing long inferencing times (e.g., 30 seconds, 45 seconds, a minute). In contrast, the client-side generative AI model can be configured or otherwise trained, as described herein, to synthesize content via high inferencing speed. That is, the client-side generative AI model can synthesize content quickly (e.g., in mere seconds, or even under a second), at the expense of exhibiting lower visual, aural, or literary quality. In other words, the server-side generative AI model can synthesize fine content slowly, whereas the client-side generative AI model can synthesize coarse content quickly. With such a distributed setup, the user can quickly and smoothly iterate with the client-side generative AI model rather than slowly and haltingly iterating with the server-side generative AI model. During such iterations, the user can provide raw source materials, the client-side generative AI model can quickly synthesize coarse (e.g., undetailed) content based on the raw source materials, and the user can incrementally edit the raw source materials until the synthesized coarse content aligns with what the user envisions or desires. When the user is satisfied with the coarse content, the client device can transmit that coarse content and its corresponding raw source material to the server device. The server device can accordingly execute the server-side generative AI model, so as to synthesize a fine (e.g., more detailed) version of that coarse content. The client device can then receive that fine version and display it to the user.

As explained herein and contrary to existing techniques, such embodiments can reduce both cumulative server-client communication overhead (e.g., there can be no need for multiple rounds of communication between the client device and the server device) and cumulative time spent on generative Al inferencing (e.g., the user can iterate with the high-speed client-side generative AI model, rather than with the high-fidelity server-side generative AI model). Such reduction in time consumption can cause there to be fewer or shorter halting, jarring, or otherwise distracting interruptions in the train of thought or workflow of the user, as compared to existing techniques.

In various embodiments, there can be a client device. In various aspects, the client device can be any suitable combination of computer-executable hardware or computer-executable software that can be utilized or otherwise operated by a user (e.g., human or otherwise). As some non-limiting examples, the client device can be a desktop computer, a laptop computer, or a smart phone. In various instances, the client device can comprise any suitable interface that enables the user to provide input information to the client device. As some non-limiting examples, the interface can be a keyboard, a keypad, a touchscreen, or a voice control system.

In various embodiments, there can be a server device that can be communicatively coupled (e.g., via the internet) to the client device. In various aspects, the server device can be any suitable combination of computer-executable hardware or computer-executable software that can perform any suitable computerized functions in response to electronic requests, instructions, or commands from the client device. Accordingly, the client device can be considered as a computerized frontend, whereas the server device can be considered as a computerized backend.

In various instances, the client device can host a first generative AI model. In various aspects, the first generative AI model can exhibit any suitable deep learning internal architecture. For example, the first generative AI model can include any suitable numbers of any suitable types of layers (e.g., input layer, one or more hidden layers, output layer, any of which can be convolutional layers, dense layers, non-linearity layers, pooling layers, batch normalization layers, or padding layers). As another example, the first generative AI model can include any suitable numbers of neurons in various layers (e.g., different layers can have the same or different numbers of neurons as each other). As yet another example, the first generative AI model can include any suitable activation functions (e.g., softmax, sigmoid, hyperbolic tangent, rectified linear unit) in various neurons (e.g., different neurons can have the same or different activation functions as each other). As still another example, the first generative AI model can include any suitable interneuron connections or interlayer connections (e.g., forward connections, skip connections, recurrent connections).

Regardless of its internal architecture, the first generative AI model can be configured to synthesize coarse generative outputs based on input prompts. That is, for any given input prompt, the client device can execute the first generative AI model on the given input prompt, and such execution can cause the first generative AI model to produce a coarse generative output based on that given input prompt. More specifically, the client device can feed the given input prompt to an input layer of the first generative AI model, the input prompt can complete a forward pass through one or more hidden layers of the first generative AI model, and an output layer of the first generative AI model can calculate the coarse generative output based on activations from the one or more hidden layers of the first generative AI model.

In various aspects, an input prompt can be any suitable electronic data that can have any suitable format, size, or dimensionality and that can be specified or otherwise provided by the user (e.g., via an interface of the client device). A coarse generative output, on the other hand, can be any suitable electronic data that can have a larger format, size, or dimensionality than that of a respective input prompt, that can be substantively related to the respective input prompt, and that can have a perceptible quality that is below any suitable threshold level.

As a non-limiting example, an input prompt can be one or more text strings typed into the client device by the user, and a coarse generative output can be an image (e.g., a two-dimensional pixel array) or video (e.g., a timeseries of two-dimensional pixel arrays) that visually depicts whatever is verbally described in the one or more text strings. Moreover, a visual quality of the image or video can be below any suitable threshold. For instance, the image or video can have a low resolution or can be in black-and-white. In such case, the first generative AI model can be considered as being configured to perform a text-to-image or text-to-video transformation.

As even another non-limiting example, an input prompt can be one or more first text strings typed into the client device by the user, and a coarse generative output can be an essay or story (e.g., a lengthy sequence of second text strings) that verbally expound upon whatever is verbally described in the one or more first text strings. Similar to above, a literary quality of the essay or story can be below any suitable threshold. For instance, the essay or story can lack proper punctuation or can be composed of sentence fragments. In such case, the first generative AI model can be considered as being configured to perform a text-to-text transformation.

As yet another non-limiting example, an input prompt can be one or more text strings typed into the client device by the user, and a coarse generative output can be a sound recording that audibly mimics or otherwise serves as appropriate music or sound for whatever is verbally described in the one or more text strings. Like above, an aural quality of the sound recording can be below any suitable threshold. For instance, the sound recording can exhibit a low sampling rate, can exhibit a base melody without any underlying accompaniment, or can exclude volume or tempo variations. In such case, the first generative AI model can be considered as being configured to perform a text-to-music transformation.

In various cases, the server device can host a second generative AI model. In various aspects, the second generative AI model can exhibit any suitable deep learning internal architecture. That is, the second generative AI model can include any suitable numbers of any suitable types of layers, can include any suitable numbers of neurons in various layers, can include any suitable activation functions in various neurons, or can include any suitable interneuron connections or interlayer connections.

Regardless of its internal architecture, the second generative AI model can be configured to synthesize fine generative outputs based on input prompts or based on coarse generative outputs. That is, for any given set of input prompts or coarse generative outputs, the server device can execute the second generative AI model on the given set of input prompts or coarse generative outputs, and such execution can cause the second generative AI model to produce a fine generative output based on that given set of input prompts or coarse generative outputs. More specifically, the server device can feed the given set of input prompts or coarse generative outputs to an input layer of the second generative AI model, the given set of input prompts or coarse generative outputs can complete a forward pass through one or more hidden layers of the second generative AI model, and an output layer of the second generative AI model can calculate the fine generative output based on activations from the one or more hidden layers of the second generative AI model.

In various aspects, a fine generative output can be any suitable electronic data that can have a same or larger format, size, or dimensionality as one or more respective coarse generative outputs and that can have a perceptible quality that is above any suitable threshold level. In other words, the fine generative output can be considered as an improved, higher-quality, more-detailed version of the one or more respective coarse generative outputs.

As a non-limiting example, suppose that a coarse generative output is an image or video depicting a particular event and having a low spatial resolution or being in black-and-white. In such case, a fine generative output can instead be an image or video depicting that same particular event, but having a high spatial resolution or being in color. In this way, the fine generative output can be considered an improved, higher-visual-quality version of the coarse generative output.

As another non-limiting example, suppose that a coarse generative output is an essay or story describing a particular event and lacking proper punctuation or being composed of sentence fragments. In such case, a fine generative output can instead be an essay or story describing that same particular event, but having proper punctuation or being composed of complete sentences. In this way, the fine generative output can be considered an improved, higher-literary-quality version of the coarse generative output.

As yet another non-limiting example, suppose that a coarse generative output is a sound recording associated with a particular event and exhibiting a low sampling rate, exhibiting a base melody without any underlying accompaniment, or excluding volume or tempo variations. In such case, a fine generative output can instead be a sound recording associated with that same particular event, but exhibiting a high sampling rate, exhibiting a base melody and underlying accompaniment, or including volume or tempo variations. In this way, the fine generative output can be considered an improved, higher-aural-quality version of the coarse generative output.

Note that, because the first generative AI model can be configured to synthesize coarse generative outputs, the first generative AI model can exhibit quick inferencing speed or, equivalently, short inferencing time. Indeed, the coarser the generative outputs of the first generative AI model, the faster the first generative AI model can be (e.g., can execute in one second or even less time). Conversely, because the second generative AI model can be configured to synthesize fine generative outputs, the second generative AI model can exhibit slow inferencing speed or, equivalently, long inferencing time. In fact, the finer the generative outputs of the second generative AI model, the slower the second generative AI model can be (e.g., can execute in 30 seconds, 45 seconds, or even a minute). In other words, the first generative AI model can be considered as being configured for quicker inferencing speed at the expense of lower inferencing fidelity, whereas the second generative AI model can instead be considered as being configured for higher inferencing fidelity at the expense of lower inferencing speed.

In various embodiments, the user of the client device can desire to synthesize a specific content. In various aspects, such synthesis can be facilitated in distributed fashion by the client device and by the server device. In particular, such synthesis can involve an iterative drafting phase and a finalization phase.

In various instances, the iterative drafting phase can occur between the user and the client device. In various cases, during the iterative drafting phase, the client device can generate a prompt-output history, by performing any suitable number of drafting iterations with the user. In various aspects, during any given drafting iteration, the client device can: query the user for an input prompt; execute the first generative AI model on that input prompt, thereby yielding a coarse generative output based on that input prompt; render or play that coarse generative output for viewing or listening by the user; and query the user for approval or disapproval of the coarse generative output (e.g., ask the user whether the coarse generative output is aligned with what the user envisions or desires). If the user so wishes, the user can edit or update the input prompt however they desire, and a next drafting iteration can be performed with respect to that edited or updated input prompt (e.g., the client device can execute the first generative AI model on that edited or updated input prompt, thereby yielding an edited or updated coarse generative output, and the user can approve or disapprove of that edited or updated coarse generative output). In this way, drafting iterations can be repetitively performed any suitable number of times. In various instances, the client device can record or otherwise log each input prompt that is received from the user, each coarse generative output that is synthesized by the first generative AI model, and whether each coarse generative output was approved or disapproved by the user. In various cases, such recorded input prompts, coarse generative outputs, and approvals or disapprovals can be considered as collectively forming a prompt-output history associated with the iterative drafting phase. Accordingly, the prompt-output history can grow with each drafting iteration that is performed.

When the user desires to cease performing drafting iterations, the prompt-output history can be considered as now being complete, and the finalization phase can be performed. In various aspects, the finalization phase can occur between the client device and the server device. In various instances, during the finalization phase, the client device can transmit to the server device the prompt-output history (e.g., all or at least some portion of the prompt-output history). In various cases, the server device can execute the second generative AI model on the prompt-output history (or on whatever portion of the prompt-output history has been transmitted to the server device), thereby yielding a fine generative output based on the prompt-output history. In various aspects, the server device can transmit the fine generative output back to the client device; and the client device can render or play the fine generative output for viewing or listening by the user. In various instances, the fine generative output can be considered as an improved, higher-quality, more-detailed version of various of the coarse generative outputs that are contained within the prompt-output history. In particular, the second generative AI model can have synthesized the fine generative output to be similar to whichever coarse generative outputs in the prompt-output history were approved by the user and to be dissimilar to whichever coarse generative outputs in the prompt-output history were disapproved by the user.

In this way, high quality content in accordance with what the user envisions or desires can be synthesized, without excessive consumption of time and thus without excessive interruption of the user's workflow. Indeed, as explained above, the user can iterate with the first generative AI model hosted on the client device rather than with the second generative AI model hosted on the server device. Such client-side iteration can reduce communication overhead between the client device and the server device. In fact, according to various embodiments, the client device and the server device can engage in a single round of communication (e.g., to transmit the prompt-output history and the fine generative output), no matter how many generative iterations the user performs. Contrast this with various existing techniques that require the client device and the server device to engage in a distinct communication round for each generative iteration the user performs. Moreover, the client-side iteration described herein can save substantial inferencing time. After all, the client can iterate with the first generative AI model instead of the second generative AI model. Since the first generative AI model can execute in mere seconds, repetitive iteration with the first generative AI model can be considered as not frustrating from the user's perspective. Contrast this with various existing techniques that would instead require the user to iterate with the second generative AI model or with a local copy of the second generative AI model. Indeed, since the second generative AI model can execute in tens, dozens, or even hundreds of seconds, repetitive iteration with it or with a local copy of it would be considered as frustrating from the user's perspective. In any case, the reduced communication overhead and inferencing time achievable by various embodiments described herein can cause a commensurate reduction or shortening of interruptions of the user's train-of-thought or workflow, which can be desirable.

Various embodiments described herein can be employed to use hardware or software to solve problems that are highly technical in nature (e.g., to facilitate distributed generative AI for improved user workflow), that are not abstract and that cannot be performed as a set of mental acts by a human. Further, some of the processes performed can be performed by a specialized computer (e.g., deep learning neural networks having internal parameters such as convolutional kernels) for carrying out defined acts related to generative AI.

For example, such defined acts can include: generating, by a client device operatively coupled to a processor, a prompt-output history comprising a set of input prompts and a set of coarse outputs, by sequentially performing a set of drafting iterations, wherein a drafting iteration comprises: querying, by the client device, a user for a respective one of the set of input prompts, which is an edited version of a previous input prompt that was provided by the user during a previous drafting iteration; and synthesizing, by the client device, a respective one of the set of coarse outputs, by executing, on the respective one of the set of input prompts, a first generative artificial intelligence model that is hosted by the client device; and instructing, by the client device, a server device to synthesize a fine output by executing, on at least part of the prompt-output history, a second generative artificial intelligence model hosted by the server device, wherein the first generative artificial intelligence model exhibits lower fidelity but quicker inferencing time than the second generative artificial intelligence model.

Such defined acts are not performed manually by humans. After all, neither the human mind nor a human with pen and paper can electronically synthesize content by executing generative AI models. Indeed, a generative AI model can be structured as a deep learning neural network, and a deep learning neural network is an inherently-computerized construct that cannot be meaningfully executed or trained in any way by the human mind without computers. Accordingly, a computerized tool that can execute deep learning neural networks in a distributed fashion so as to synthesize generative content is likewise inherently-computerized and cannot be implemented in any sensible, practical, or reasonable way without computers.

Moreover, various embodiments described herein can integrate into a practical application various teachings relating to distributed generative AI for improved user workflow. As explained above, some existing techniques host a generative AI model on a server device, and a user can utilize a client device so as to remotely iterate with the generative AI model. Unfortunately, such existing techniques excessively accumulate communication overhead between the client device and the server device (e.g., in the form of repeated transmission of input prompts and synthesized content back and forth between the client device and the server device). Additionally, such existing techniques excessively accumulate inferencing time (e.g., the server-side generative AI model can consume tens, dozens, or even hundreds of seconds of inferencing time during each iteration). Accordingly, such existing techniques can cause a user to experience repeated and extensive bouts of waiting (e.g., each iteration can involve waiting for the client device and the server device to communicate and waiting for the generative AI model to execute), which can haltingly or jarringly interrupt the user's train of thought or workflow. As also explained above, other existing techniques involve downloading a local copy of the generative AI model from the server device to the client device. When such other existing techniques are implemented, the user can iterate with the local copy of the generative AI model without accumulating excessive communication overhead between the client device and the server device. However, such other existing techniques can nevertheless suffer from excessive accumulation of inferencing time (e.g., the local copy of the generative AI model can consume tens, dozens, or even hundreds of seconds of inferencing time during each iteration). Again, the end result is that the user experiences repeated and extensive bouts of waiting, which can haltingly or jarringly interrupt the user's train of thought or workflow.

Various embodiments described herein can address one or more of these technical problems. Specifically, the inventors of various embodiments described herein realized that the excessive time consumption of existing techniques can be ameliorated via a distributed generative Al setup. In particular, such distributed generative AI setup can include a generative AI model being hosted on the client device and another generative AI model being hosted on the server device. In various aspects, the server-side generative AI model can be configured for high fidelity inferencing, whereas the client-side generative AI model can instead be configured for quick inferencing. In other words, the server-side generative AI model can synthesize high-quality content slowly (e.g., in tens, dozens, or hundreds of seconds per execution), and the client-side generative AI model can instead synthesize low-quality content quickly (e.g., in mere seconds, or even under a second, per execution). Thus, the user can, without much waiting or downtime, iterate with the client-side generative AI model so as to synthesize a rough-draft of content that the user finds satisfactory. Once such satisfactory rough-draft is obtained, it and its associated input prompt can be sent to the server-side generative AI model such that a higher-quality version of that content can be synthesized.

As described herein, the distributed generative Al setup devised by the present inventors can reduce accumulation of communication overhead between the client device and the server device (e.g., such a distributed setup can eliminate any need to repeatedly ferry input prompts and synthesized content back and forth between the client device and the server device). Furthermore, the distributed generative Al setup devised by the present inventors can also reduce accumulation of inferencing time (e.g., in such a distributed setup, iteration can occur between the user and the quick client-side generative AI model, rather than between the user and the slow server-side generative AI model (or a local copy thereof)). Accordingly, various embodiments described herein can reduce communication time and inferencing time, and can thus provide a smoother, less frustrating user experience, as compared to existing techniques. For at least these reasons, various embodiments described herein certainly constitute concrete and tangible technical improvements in the field of generative AI, and such embodiments therefore clearly qualify as useful and practical applications of computers.

Furthermore, various embodiments described herein can control real-world tangible devices based on the disclosed teachings. For example, various embodiments described herein can electronically execute or train real-world deep learning neural networks.

It should be appreciated that the herein figures and description provide non-limiting examples of various embodiments and are not necessarily drawn to scale.

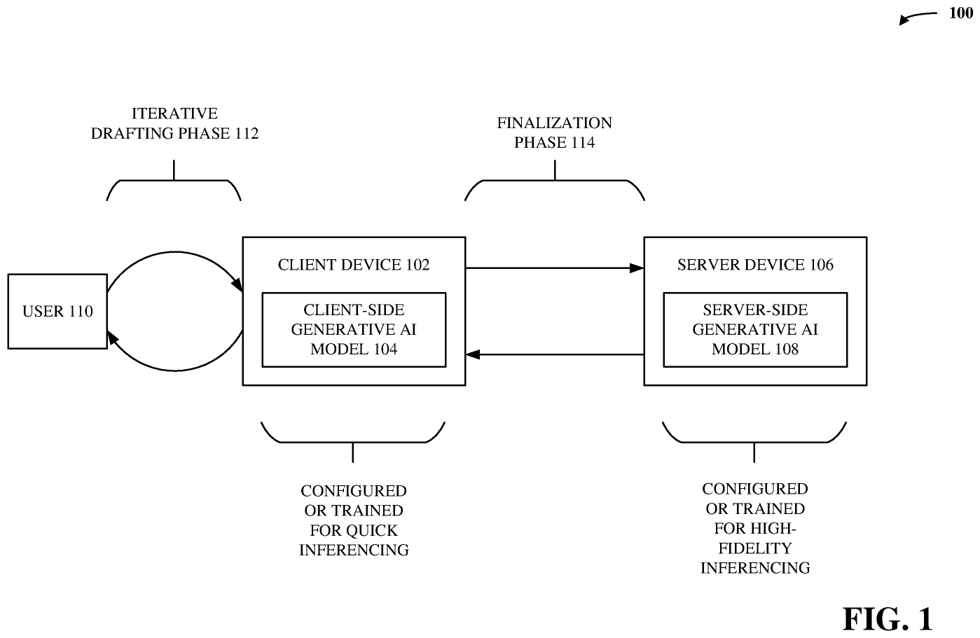

FIG. 1 illustrates a block diagram 100 of an example, non-limiting system that can facilitate distributed generative artificial intelligence for improved user workflow in accordance with one or more embodiments described herein.

In various embodiments, there can be a client device 102. In various aspects, the client device 102 can be any suitable computerized device that can interface with or otherwise be operated by a user 110. As a non-limiting example, the client device 102 can be a desktop computer. As another non-limiting example, the client device 102 can be a laptop computer. As yet another non-limiting example, the client device 102 can be a smart phone or tablet. As still another non-limiting example, the client device 102 can be a vehicle-integrated computer. As even another non-limiting example, the client device 102 can be a wearable computer, such as a smart watch or smart glasses.

In various instances, the client device 102 can electronically receive or otherwise electronically access, in any suitable interfacing fashion, information provided by the user 110. As a non-limiting example, the client device 102 can comprise or otherwise be equipped with one or more keyboards or keypads. In such case, the user 110 can supply information to the client device 102 by pressing physical buttons on those one or more keyboards or keypads. As another non-limiting example, the client device 102 can comprise or otherwise be equipped with one or more touchscreens. In such case, the user 110 can supply information to the client device 102 by pressing electronic icons displayed on those one or more touchscreens. As yet another non-limiting example, the client device 102 can comprise or otherwise be equipped with one or more microphones. In such case, the user 110 can supply information to the client device 102 by speaking verbal commands into those one or more microphones. As still another non-limiting example, the client device 102 can comprise or otherwise be outfitted with one or more cameras. In such case, the user 110 can supply videographic information to the client device 102 by capturing images or videos with those one or more cameras. As even another non-limiting example, the client device 102 can comprise or otherwise be equipped with one or more data ports. In such case, the user 110 can supply information to the client device 102 by inserting flash drives or memory sticks into those one or more data ports.

In various aspects, the client device 102 can electronically render or otherwise electronically play-back information to the user 110. As a non-limiting example, the client device 102 can comprise or otherwise be equipped with one or more electronic displays (e.g., computer screens or monitors). In such cases, the client device 102 can electronically render videographic information on those one or more electronic displays, such that the videographic information can be viewed by the user 110. As another non-limiting example, the client device 102 can comprise or otherwise be equipped with one or more speakers. In such case, the client device 102 can electronically play audio information on those one or more speakers, such that the audio information can be heard by the user 110.

In various embodiments, the client device 102 can be electronically integrated, via any suitable wired or wireless electronic connections, with a server device 106. In various aspects, the server device 106 can be any suitable computerized device that can provide any suitable computerized functionality to (e.g., that can serve) the client device 102. In other words, the server device 106 can electronically respond to electronic instructions, electronic commands, or electronic requests that are transmitted by the client device 102.

Note that, in various instances, the client device 102 can be considered as forming or otherwise acting as a frontend of a computing environment. In contrast, the server device 106 can be considered as forming or otherwise acting as a backend of the computing environment.

In various aspects, the client device 102 can host a client-side generative AI model 104. In various embodiments, the client-side generative AI model 104 can be any suitable deep learning neural network that can have or otherwise exhibit any suitable internal architecture. For instance, the client-side generative AI model 104 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In various aspects, the client-side generative AI model 104 can be configured to synthesize a coarse generative output when executed on an input prompt. In various aspects, an input prompt can be any suitable electronic data that can have any suitable format, size, or dimensionality, and that can be provided, supplied, or otherwise specified in any suitable fashion by the user 110. In other words, an input prompt can be one or more scalars, one or more vectors, one or more matrices, one or more tensors, one or more character strings, or any suitable combination thereof, that can be: typed by the user 110 into a keyboard, keypad, or touchscreen of the client device 102; spoken by the user 110 into a microphone of the client device 102; captured or read at the behest of the user 110 by a camera of the client device 102; inserted by the user 110 into a data port of the client device 102; or otherwise electronically accessed (e.g., via an internet connection) at the behest of the user 110 by client device 102.

As a non-limiting example, an input prompt can be one or more text strings (e.g., can be a short textual description) provided or selected by the user 110. In some instances, such text strings can be typed by the user 110 into the client device 102. In other instances, such text strings can be otherwise accessed (e.g., via the internet) by the client device 102 at the behest of the user 110. In some cases, such text strings can be unaffected or unaltered by augmented reality textual filters. However, in other cases, such text strings can be affected or altered by augmented reality textual filters.

As another non-limiting example, an input prompt can be one or more images (e.g., two-dimensional pixel arrays or three-dimensional voxel arrays) provided by the user 110. In some instances, such images can be captured by a camera of the client device 102 or drawn onto a touchscreen of the client device 102 at the behest of the user 110. In other instances, such images can be otherwise accessed (e.g., via the internet) by the client device 102 at the behest of the user 110. In some cases, such images can be unaffected or unaltered by augmented reality visual filters. However, in other cases, such images can be affected or altered by augmented reality visual filters.

As yet another non-limiting example, an input prompt can be one or more videos (e.g., timeseries of two-dimensional pixel arrays or timeseries of three-dimensional voxel arrays) provided by the user 110. In some instances, such videos can be captured by a camera of the client device 102 at the behest of the user 110. In other instances, such videos can be otherwise accessed (e.g., via the internet) by the client device 102 at the behest of the user 110. In some cases, such videos can be unaffected or unaltered by augmented reality visual filters. However, in other cases, such videos can be affected or altered by augmented reality visual filters.

As still another non-limiting example, an input prompt can be one or more sound recordings (e.g., timeseries of decibel data or audio waveforms) provided by the user 110. In some instances, such sound recordings can be captured by a microphone of the client device 102 at the behest of the user 110. In other instances, such sound recordings can be otherwise accessed (e.g., via the internet) by the client device 102 at the behest of the user 110. In some cases, such sound recordings can be unaffected or unaltered by augmented reality audio filters. However, in other cases, such sound recordings can be affected or altered by augmented reality audio filters.

As even another non-limiting example, an input prompt can be any suitable combination of any of the aforementioned.

In various aspects, a coarse generative output can correspond to a respective input prompt. In various instances, the coarse generative output can be any suitable electronic data that can have a larger format, size, or dimensionality than the respective input prompt. That is, the coarse generative output can be one or more scalars, one or more vectors, one or more matrices, one or more tensors, one or more character strings, or any suitable combination thereof, and the total cardinality of granular numerical elements that make up the coarse generative output can be greater than that which make up the respective input prompt. Furthermore, in various cases, the coarse generative output can be substantively related to the respective input prompt. In other words, the respective input prompt can textually describe, visually show, or audibly represent any suitable event, activity, or object, and whatever substance is conveyed by the coarse generative output can somehow pertain to or otherwise be in accordance with that event, activity, or object. Further still, in various aspects, the coarse generative output can exhibit a perceptible quality (e.g., a literary quality if the coarse generative output contains text, a visual quality if the coarse generative output contains images or videos, or an aural quality if the coarse generative output contains sound recordings) that is below any suitable threshold. For at least this reason, the term “coarse” can be considered as appropriate.

As a non-limiting example, an input prompt can be one or more text strings provided (e.g., typed, spoken, selected) by the user 110, and such one or more text strings can verbally describe a specific event, activity, or object. In such case, a coarse generative output corresponding to that input prompt can be a synthetic image or video that visually illustrates (or that purports or attempts to visually illustrate) that specific event, activity, or object. Additionally, a visual quality of that synthetic image or video can be below any suitable threshold level or threshold margin. Indeed, in some cases, that synthetic image or video can exhibit a spatial, pixel, or voxel resolution (or frame rate) that is below any suitable spatial, pixel, or voxel resolution (or framerate) threshold. In other cases, rather than being in color, that synthetic image or video can instead be colorless (e.g., can be in black-and-white). In yet other cases, rather than being rendered via a full color palette, that synthetic image or video can instead be rendered via a strict subset of that full color palette. In still other cases, rather than including graduated visual shading (e.g., which promotes smooth visual transitions between depicted objects), that synthetic image or video can instead lack or exclude graduated visual shading. In even other cases, rather than being made up of visual shapes having filled-in interior detail, that synthetic image or video can instead be made up of visual shape outlines that are devoid of interior detail (e.g., that are empty). In yet other cases, rather than having a busy background, that synthetic image or video can instead have an empty, blank, or otherwise sparse background. Any of these foregoing attributes can be considered as contributing to a lowered or decreased visual quality of that synthetic image or video.

As another non-limiting example, an input prompt can be one or more text strings provided by the user 110, and such one or more text strings can verbally describe a particular event, activity, or object. In such case, a coarse generative output corresponding to that input prompt can be a synthetic essay or story that verbally elaborates (or that purports or attempts to verbally elaborate) on that particular event, activity, or object. Additionally, a literary or textual quality of that synthetic essay or story can be below any suitable threshold level or threshold margin. Indeed, in some cases, rather than including punctuation, that synthetic essay or story can instead lack or exclude punctuation (e.g., can lack periods, exclamation marks, question marks, quotation marks, commas, parentheses, apostrophes, colons, semicolons, hyphens, slashes, or dashes). In other cases, rather than being made up of complete sentences, that synthetic essay or story can instead be made up of sentence fragments. In yet other cases, rather than being made up of detailed, fully-written paragraphs/sections, that synthetic essay or story can instead be made up of paragraph/section headers or paragraph/section summaries. In still other cases, rather than being made up of long, complicated words, that synthetic essay or story can instead be made up of words having fewer than any suitable threshold number of syllables or letters. Any of these foregoing attributes can be considered as contributing to a lowered or decreased literary or textual quality of that synthetic essay or story.

As yet another non-limiting example, an input prompt can be one or more text strings provided by the user 110, and such one or more text strings can verbally describe a given event, activity, or object. In such case, a coarse generative output corresponding to that input prompt can be a synthetic sound recording that audibly or aurally recreates, mimics, or otherwise aligns with (or purports or attempts to recreate, mimic, or align with) that given event, activity, or object. Additionally, an aural quality of that synthetic sound recording can be below any suitable threshold level or threshold margin. Indeed, in some cases, that synthetic sound recording can exhibit a sampling rate that is below any suitable sampling rate threshold. In other cases, rather than including multiple overlapping audio tracks, that synthetic sound recording can instead include a single audio track (e.g., can include a base melody without any underlying accompaniment). In yet other cases, that synthetic sound recording can include fewer than any suitable threshold number of overlapping audio tracks. In still other cases, rather than including multiple different types of instrument sounds, that synthetic sound recording can instead include a single type of instrument sound (e.g., can include only piano sounds and can exclude string sounds, drum sounds, woodwind sounds, and brass sounds). In even other cases, that synthetic sound recording can include fewer than any suitable threshold number of distinct types of instrument sounds. In various cases, rather than ranging over multiple octaves, that synthetic sound recording can instead range over a single octave (e.g., from C4 to C5). In other cases, that synthetic sound recording can range over fewer than any suitable threshold number of octaves. In yet other cases, rather than including all possible types of musical notes, that synthetic sound recording can instead include any suitable strict subset of the possible types of musical notes (e.g., can include whole notes and half notes, but can exclude quarter notes, eighth notes, and sixteenth notes). In still other cases, that synthetic sound recording can lack or otherwise exclude advanced musical patterns, such as trills, tremolos, reverberation, tempo changes, key changes, or volume dynamics. Any of these foregoing attributes can be considered as contributing to a lowered or decreased aural quality of that synthetic sound recording.

It is to be understood that the foregoing are mere non-limiting examples of an input prompt and a coarse generative output. In various embodiments, an input prompt can be any suitable combination of text strings, images, videos, or sound recordings that can be provided, selected, or specified by the user 110. Likewise, a coarse generative output can be any suitable combination of text strings, images, videos, or sound recordings that can be synthesized from a respective input prompt by the client-side generative AI model 104.

In various aspects, the server device 106 can host a server-side generative AI model 108. In various embodiments, the server-side generative AI model 108 can be any suitable deep learning neural network that can have or otherwise exhibit any suitable internal architecture. For instance, the server-side generative AI model 108 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

In various aspects, the server-side generative AI model 108 can be configured to synthesize a fine generative output when executed on one or more input prompts or on one or more coarse generative outputs. In various aspects, a fine generative output can be any suitable electronic data having any suitable format, size, or dimensionality. That is, a fine generative output can be one or more scalars, one or more vectors, one or more matrices, one or more tensors, one or more character strings, or any suitable combination thereof. Moreover, a fine generative output can be considered as an improved, higher-quality, or more-detailed version of one or more respective coarse generative outputs, hence the term “fine”. In other words, a coarse generative output can exhibit a perceptible quality that is below any suitable threshold, whereas a fine generative output can instead exhibit a perceptible quality that is above that threshold.

As a non-limiting example, a coarse generative output can be a synthetic image or video produced by the client-side generative AI model 104, and such synthetic image or video can visually illustrate a specific event, activity, or object. Moreover, such synthetic image or video can exhibit a sub-threshold visual quality. For instance, such sub-threshold visual quality can be due to: having less than a threshold amount of spatial, pixel, or voxel resolution; having less than a threshold frame rate; being colorless or otherwise having fewer than a threshold number of colors; lacking or excluding graduated visual shading; being composed of visual shape outlines that are empty or that otherwise lack interior detail; or including an empty, blank, or sparse visual background. In such case, a fine generative output can instead be a synthetic image or video that visually illustrates that same specific event, activity, or object according to a supra-threshold visual quality. For instance, such supra-threshold visual quality can be due to: having more than a threshold amount of spatial, pixel, or voxel resolution; having more than a threshold frame rate; being colored or otherwise having more than a threshold number of colors; including graduated visual shading; being composed of visual shape outlines that are filled or that otherwise possess interior detail; or including a non-empty, non-blank, or otherwise busy visual background.

As another non-limiting example, a coarse generative output can be a synthetic essay or story produced by the client-side generative AI model 104, and such synthetic essay or story can verbally describe a specific event, activity, or object. Moreover, such synthetic essay or story can exhibit a sub-threshold literary quality. For instance, such sub-threshold literary quality can be due to: lacking or excluding punction; being composed of sentence fragments; being composed of paragraph/section headers or summaries; or lacking or excluding words that have more a threshold number of syllables or letters. In such case, a fine generative output can instead be a synthetic essay or story that verbally describes that same specific event, activity, or object according to a supra-threshold literary quality. For instance, such supra-threshold literary quality can be due to: including punction; being composed of complete sentences; being composed of full paragraphs/sections; or including words that have more a threshold number of syllables or letters.

As yet another non-limiting example, a coarse generative output can be a synthetic sound recording produced by the client-side generative AI model 104, and such synthetic sound recording can be audibly related to a specific event, activity, or object. Moreover, such synthetic sound recording can exhibit a sub-threshold aural quality. For instance, such sub-threshold aural quality can be due to: having less than a threshold sampling rate; having fewer than a threshold number of parallel audio tracks; having fewer than a threshold number of distinct types of instrument sounds; ranging over fewer than a threshold number of octaves; lacking or excluding particular types of musical notes; or lacking or excluding advanced musical patterns such as trills, tremolos, reverberation, tempo or key variations, or volume dynamics. In such case, a fine generative output can instead be a synthetic sound recording that is audibly related to that same specific event, activity, or object according to a supra-threshold aural quality. For instance, such supra-threshold aural quality can be due to: having more than a threshold sampling rate; having more than a threshold number of parallel audio tracks; having more than a threshold number of distinct types of instrument sounds; ranging over more than a threshold number of octaves; including particular types of musical notes; or including advanced musical patterns such as trills, tremolos, reverberation, tempo or key variations, or volume dynamics.

In various aspects, because the client-side generative AI model 104 can be configured to synthesize lower-quality generative outputs than the server-side generative AI model 108, the client-side generative AI model 104 can exhibit a faster or quicker inferencing speed, and thus a shorter inferencing time, than the server-side generative AI model 108. After all, the client-side generative AI model 104 can be considered as synthesizing generative outputs using a smaller, less complicated feature range (e.g., using less resolution, using fewer colors, using fewer or shorter words, using fewer audio tracks, using less detail overall), and it can simply take less time or less processing capacity to synthesize generative outputs in such a smaller, less complicated feature range. In contrast, the server-side generative AI model 108 can instead be considered as synthesizing generative outputs using a larger, more complicated feature range (e.g., using more resolution, using more colors, using more or longer words, using more audio tracks, using more detail overall), and it can simply take more time and more processing capacity to synthesize generative outputs in such a larger, more complicated feature range. Thus, in various instances, the client-side generative AI model 104 can be considered as being configured for quicker inferencing (in exchange for lower inferencing fidelity or quality). On the other hand, the server-side generative AI model 108 can instead be considered as being configured for higher inferencing fidelity or quality (in exchange for slower inferencing speed). Indeed, in some cases, the client-side generative AI model 104 can consume an inferencing time of a few seconds (or even shorter) per execution, whereas the server-side generative AI model 108 can instead consume an inferencing time on the order of 30 or 45 seconds (or even longer) per execution.

In various embodiments, the user 110 can envision or desire some specific content to be synthesized. In various aspects, the client device 102 and the server device 106 can collectively work in distributed fashion to synthesize that specific content. In various cases, such synthesis can involve an iterative drafting phase 112 and a finalization phase 114.

In various aspects, the iterative drafting phase 112 can comprise a set of drafting iterations. In various instances, during each drafting iteration, the client device 102 can, as described herein, receive an input prompt from the user 110, execute the client-side generative AI model 104 on that input prompt so as to yield a coarse generative output, and receive approval or disapproval of that coarse generative output from the user 110. The client device 102 can then proceed to a next drafting iteration, if the user 110 so desires. During a beginning drafting iteration of the iterative drafting phase 112, the input prompt provided by the user 110 can be an original or initial input prompt. In contrast, during any later drafting iteration of the iterative drafting phase 112, the input prompt can be an edited version of a prior input prompt. In various cases, the input prompts, the coarse generative outputs, and the approvals or disapprovals of the coarse generative outputs can collectively be considered as forming a prompt-output history of the iterative drafting phase 112.

In various aspects, the user 110 can cease the iterative drafting phase 112 whenever they desire (e.g., whenever they believe that a most recent coarse generative output closely aligns, albeit in low-quality fashion, with the specific content that they envision). Upon such cessation, the finalization phase 114 can commence. In various instances, during the finalization phase 114, the client device 102 can electronically share the prompt-output history (or any portion thereof) with the server device 106. In various cases, as described herein, the server device 106 can execute the server-side generative AI model 108 on the prompt-output history, and such execution can yield a fine generative output. In various aspects, the fine generative output can be a considered as a higher-quality version of whichever coarse generative outputs in the prompt-output history were approved by the user 110. In various instances, the server device 106 can share the fine generative output with the client device 102, and the client device 102 can electronically render or play the fine generative output for the user 110.

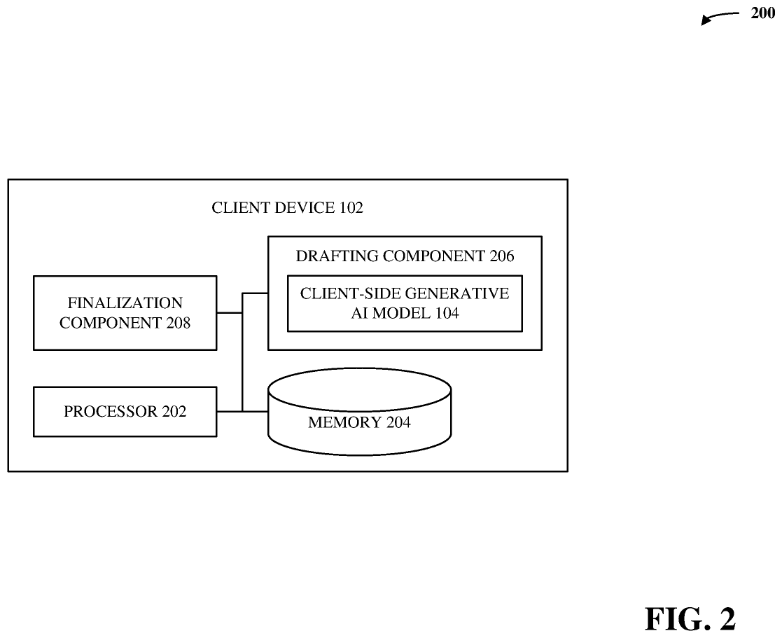

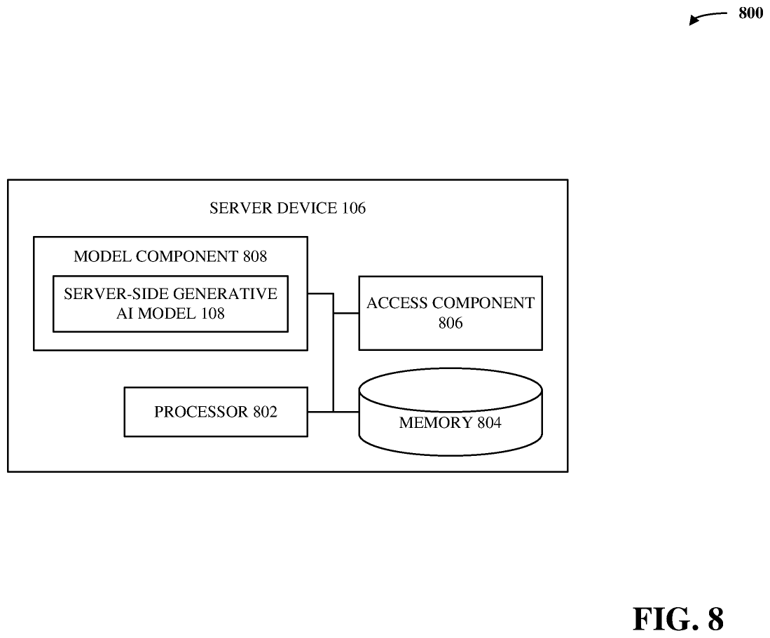

Various non-limiting aspects regarding the client device 102 and the iterative drafting phase 112 are described with respect to FIGS. 2-7. Various non-limiting aspects regarding the server device 106 and the finalization phase 114 are described with respect to FIGS. 8-11.

FIG. 2 illustrates an example, non-limiting block diagram 200 of the client device 102 in accordance with one or more embodiments described herein.

In various embodiments, the client device 102 can comprise a processor 202 (e.g., computer processing unit, microprocessor) and a non-transitory computer-readable memory 204 that is operably or operatively or communicatively connected or coupled to the processor 202. The non-transitory computer-readable memory 204 can store computer-executable instructions which, upon execution by the processor 202, can cause the processor 202 or other components of the client device 102 (e.g., drafting component 206, finalization component 208) to perform one or more acts. In various embodiments, the non-transitory computer-readable memory 204 can store computer-executable components (e.g., drafting component 206, finalization component 208), and the processor 202 can execute the computer-executable components.

In various embodiments, as shown, the client device 102 can comprise a drafting component 206. In various aspects, the drafting component 206 can electronically host, electronically store, electronically maintain, or otherwise electronically control the client-side generative AI model 104. In various instances, as described herein, the drafting component 206 can facilitate the iterative drafting phase 112 with the user 110. In particular, the drafting component 206 can, as described herein, leverage the client-side generative AI model 104 to perform a set of drafting iterations, where each drafting iteration can incrementally build a prompt-output history comprising input prompts provided by the user 110 and coarse generative outputs synthesized by the client-side generative AI model 104.

In various embodiments, as shown, the client device 102 can comprise a finalization component 208. In various aspects, the finalization component 208 can, in response to the iterative drafting phase 112 being terminated by the user 110, initiate the finalization phase 114. In particular, the finalization component 208 can electronically transmit to the server device 106 a finalization instruction, where the finalization instruction can request or command that the server device 106 synthesize, based on the prompt-output history, a fine generative output using the server-side generative AI model 108.

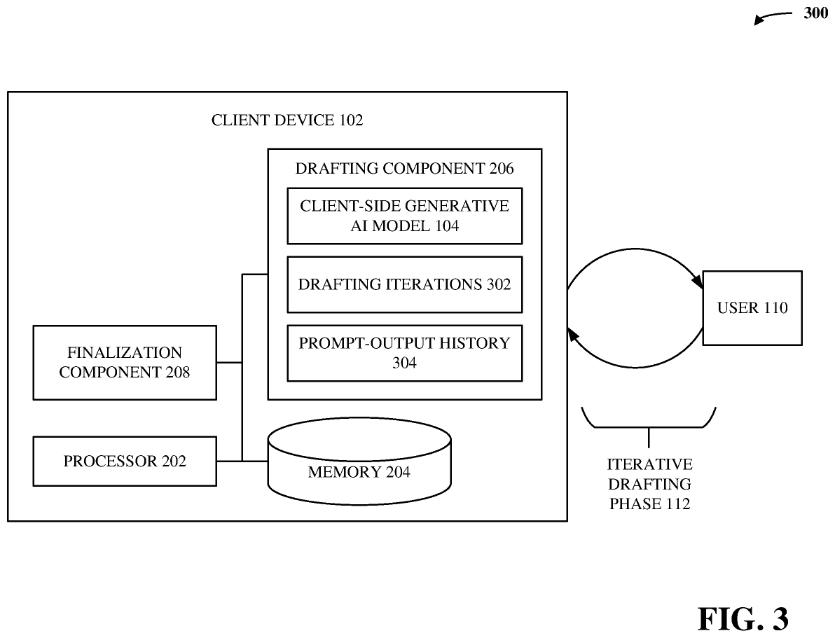

FIG. 3 illustrates an example, non-limiting block diagram 300 of the client device 102 in accordance with one or more embodiments described herein. As shown, the block diagram 300 can, in some cases, include the same components as the block diagram 200, and can further include a set of drafting iterations 302 and a prompt-output history 304.

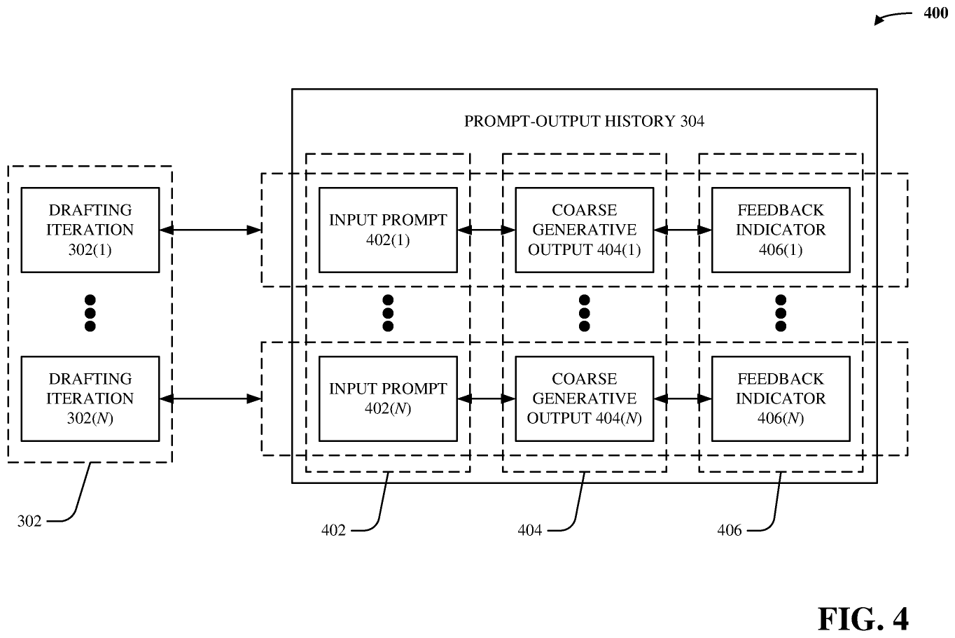

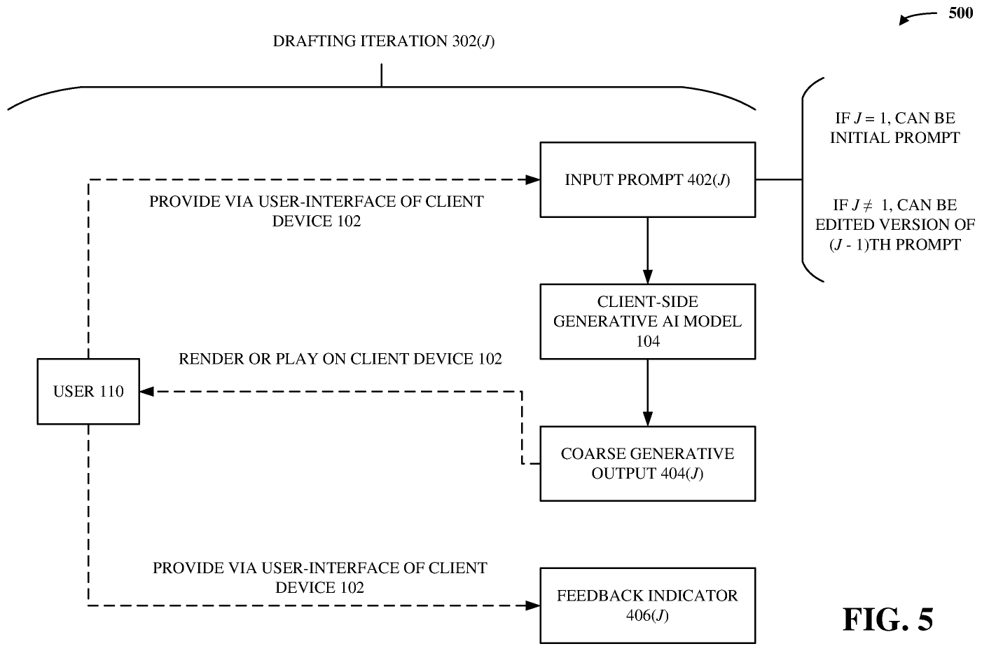

In various embodiments, the drafting component 206 can electronically facilitate the iterative drafting phase 112 with the user 110. In various aspects, the iterative drafting phase 112 can comprise the set of drafting iterations 302, where the set of drafting iterations 302 can include any suitable number of drafting iterations. In various instances, during each of the set of drafting iterations 302, the user 110 can provide a respective input prompt to the client device 102, the drafting component 206 can execute the client-side generative AI model 104 to synthesize a respective coarse generative output based on that respective input prompt, and the drafting component 206 can query the user 110 for an indication of approval or disapproval of the respective coarse generative output. Such input prompts, coarse generative outputs, and approvals or disapprovals can be considered as collectively forming the prompt-output history 304. Various non-limiting aspects are described with respect to FIGS. 4-5.

FIG. 4 illustrates an example, non-limiting block diagram 400 showing an example, non-limiting embodiment of the prompt-output history 304 in accordance with one or more embodiments described herein.

In various aspects, as shown, the set of drafting iterations 302 can comprise n iterations for any suitable positive integer n: a drafting iteration 302(1) to a drafting iteration 302(n). In various instances, each of the set of drafting iterations 302 can be considered as a distinct round of communication or interaction between the client device 102 and the user 110 during the iterative drafting phase 112. Accordingly, the drafting iteration 302(1) can be considered a first round of communication or iteration during which the user 110 provides information to the client device 102 and the client device 102 responds to the user 110. Similarly, the drafting iteration 302(n) can be considered an n-th round of communication or iteration during which the user 110 provides information to the client device 102 and the client device 102 responds to the user 110.

In various instances, as shown, the prompt-output history 304 can comprise a set of input prompts 402. In various cases, the set of input prompts 402 can respectively correspond (e.g., in one-to-one fashion) with the set of drafting iterations 302. Accordingly, since the set of drafting iterations 302 can comprise n iterations, the set of input prompts 402 can likewise comprise n prompts: an input prompt 402(1) to an input prompt 402(n). In various aspects, each of the set of input prompts 402 can be any suitable input prompt that can have been provided by the user 110 during a respective one of the set of drafting iterations 302. As a non-limiting example, the input prompt 402(1) can correspond to the drafting iteration 302(1). Thus, the input prompt 402(1) can be whatever text strings, images, videos, or sound recordings that the user 110 typed into the client device 102, spoke into the client device 102, captured with the client device 102, supplied to the client device 102, or otherwise accessed via the client device 102 during the drafting iteration 302(1). As another non-limiting example, the input prompt 402(n) can correspond to the drafting iteration 302(n). So, the input prompt 402(n) can be whatever text strings, images, videos, or sound recordings that the user 110 typed into the client device 102, spoke into the client device 102, captured with the client device 102, supplied to the client device 102, or otherwise accessed via the client device 102 during the drafting iteration 302(n).

In various aspects, as shown, the prompt-output history 304 can comprise a set of coarse generative outputs 404. In various instances, the set of coarse generative outputs 404 can respectively correspond (e.g., in one-to-one fashion) to the set of input prompts 402, and thus to the set of drafting iterations 302. Accordingly, since the set of drafting iterations 302 can comprise n iterations, and since the set of input prompts 402 can comprise n prompts, the set of coarse generative outputs 404 can likewise comprise n outputs: a coarse generative output 404(1) to a coarse generative output 404(n). In various cases, each of the set of coarse generative outputs 404 can be any suitable coarse generative output synthesized by the client-side generative AI model 104 during a respective one of the set of drafting iterations 302 and based on a respective one of the set of input prompts 402. As a non-limiting example, the coarse generative output 404(1) can correspond to the input prompt 402(1) and to the drafting iteration 302(1). Thus, the coarse generative output 404(1) can be whatever synthetic text strings, synthetic images, synthetic videos, or synthetic sound recordings are produced, during the drafting iteration 302(1), via execution of the client-side generative AI model 104 on the input prompt 402(1). As another non-limiting example, the coarse generative output 404(n) can correspond to the input prompt 402(n) and to the drafting iteration 302(n). So, the coarse generative output 404(n) can be whatever synthetic text strings, synthetic images, synthetic videos, or synthetic sound recordings are produced, during the drafting iteration 302(n), via execution of the client-side generative AI model 104 on the input prompt 402(n).

In various aspects, as shown, the prompt-output history 304 can comprise a set of feedback indicators 406. In various instances, the set of feedback indicators 406 can respectively correspond (e.g., in one-to-one fashion) to the set of coarse generative outputs 404, and thus to the set of input prompts 402 and to the set of drafting iterations 302. Accordingly, since the set of coarse generative outputs 404 comprises n outputs, since the set of input prompts 402 comprises n inputs, and since the set of drafting iterations comprises n iterations, the set of feedback indicators 406 can likewise comprise n indicators: a feedback indicator 406(1) to a feedback indicator 406(n). In various cases, each of the set of feedback indicators 406 can be any suitable electronic data that can indicate whether the user 110 approves or disapproves of a respective one of the set of coarse generative outputs 404. As a non-limiting example, the feedback indicator 406(1) can correspond to the coarse generative output 404(1), and thus to the input prompt 402(1) and to the drafting iteration 302(1). Thus, the feedback indicator 406(1) can be a binary or dichotomous variable that can take one of two possible states. One of those two possible states can indicate, convey, or otherwise represent that the user 110 has approved or accepted the coarse generative output 404(1) (e.g., can indicate, convey, or otherwise represent that the user 110 has signaled that the coarse generative output 404(1) is consistent with whatever synthesized content the user envisions or desires). The other of those two possible states can instead indicate, convey, or otherwise represent that the user 110 has disapproved or rejected the coarse generative output 404(1) (e.g., can indicate, convey, or otherwise represent that the user 110 has signaled that the coarse generative output 404(1) is inconsistent with whatever synthesized content the user 110 envisions or desires). As another non-limiting example, the feedback indicator 406(n) can correspond to the coarse generative output 404(n). So, the feedback indicator 406(n) can be a binary or dichotomous variable indicating, conveying, or otherwise representing whether the use approves or disapproves of the coarse generative output 404(n) (e.g., indicating, conveying, or otherwise representing whether the user 110 has signaled that the coarse generative output 404(n) is consistent or inconsistent with whatever synthetic content the user 110 envisions or desires).

FIG. 5 illustrates an example, non-limiting block diagram 500 showing how any of the set of drafting iterations 302 can be performed by the drafting component 206 in accordance with one or more embodiments described herein. In particular, FIG. 5 can be considered as illustrating how a j-th drafting iteration can be performed, for any suitable positive integer j≤n. In various cases, such j-th drafting iteration can be referred to as a drafting iteration 302(j).

In various aspects, during the drafting iteration 302(j), the drafting component 206 can query the user 110 for an input prompt. Accordingly, in response to such query, the user 110 can provide or otherwise supply (e.g., via a keyboard, keypad, touchscreen, voice command, camera, data port, or other user-interface) an input prompt 402(j) to the drafting component 206. In various instances, the input prompt 402(j) can be considered as being a j-th one of the set of input prompts 402. If j=1 (e.g., if the drafting iteration 302(j) is the initial, beginning, or otherwise chronologically first drafting iteration of the iterative drafting phase 112), then the input prompt 402(j) can be considered as an initial, beginning, or otherwise original input prompt provided or supplied by the user 110. However, if j≠1 (e.g., if the drafting iteration 302(j) is not the initial, beginning, or otherwise chronologically first drafting iteration of the iterative drafting phase 112), then the input prompt 402(j) can instead be an edited, updated, or altered version of any previous or prior input prompt that was provided or supplied by the user 110 during a respective previous or prior drafting iteration. As a non-limiting example, the input prompt 402(j) can be an edited, updated, changed, or altered version of an input prompt 402(j−1) (e.g., of whatever input prompt was provided or supplied by the user 110 during a (j−1)-th drafting iteration).

In various instances, the drafting component 206 can electronically execute the client-side generative AI model 104 on the input prompt 402(j). In various cases, such execution can cause the client-side generative AI model 104 to synthesize a coarse generative output 404(j), which can be considered as being a j-th one of the set of coarse generative outputs 404. More specifically, the drafting component 206 can feed or otherwise pass the input prompt 402(j) to an input layer of the client-side generative AI model 104. In various instances, the input prompt 402(j) can complete a forward pass through one or more hidden layers of the client-side generative AI model 104. In various cases, an output layer of the client-side generative AI model 104 can calculate or compute the coarse generative output 404(j), based on activation maps generated by the one or more hidden layers of the client-side generative AI model 104. Just as explained above, the coarse generative output 404(j) can be considered as synthetic content (e.g., synthetic text, images, videos, or sound recordings) that is substantively related to the input prompt 402(j) and that exhibits any suitable sub-threshold quality or fidelity (e.g., sub-threshold visual, literary, or aural qualities or fidelities).

In various aspects, the drafting component 206 can electronically render or play the coarse generative output 404(j) on the client device 102, such that the coarse generative output 404(j) can be evaluated or judged by the user 110. As a non-limiting example, if the coarse generative output 404(j) includes text, images, or videos, the drafting component 206 can visually render such text images, or videos on any suitable computer screen or monitor of the client device 102. Accordingly, the user 110 can view such text, images, or videos. As another non-limiting example, if the coarse generative output 404(j) includes sound recordings, the drafting component 206 can audibly play such sound recordings on any suitable speakers of the client device 102. Thus, the user 110 can listen to such sound recordings.

In various instances, the drafting component 206 can query the user 110 for feedback regarding the coarse generative output 404(j). Accordingly, in response to such query, the user 110 can provide or otherwise supply (e.g., via a keyboard, keypad, touchscreen, voice command, camera, data port, or other user-interface) a feedback indicator 406(j) to the drafting component 206. In various instances, the feedback indicator 406(j) can be considered as being a j-th one of the set of feedback indicators 406. In some cases, the feedback indicator 406(j) can indicate that the user 110 has accepted or approved the coarse generative output 404(j). That is, the user 110 can have determined that the coarse generative output 404(j) is consistent with or otherwise close to whatever synthetic content the user 110 envisions or desires. In other cases, the feedback indicator 406(j) can instead indicate that the user 110 has rejected or disapproved the coarse generative output 404(j). That is, the user 110 can have determined that the coarse generative output 404(j) is inconsistent with or otherwise not close to whatever synthetic content the user 110 envisions or desires.

In various aspects, the drafting component 206 can, during the drafting iteration 302(j), electronically insert, record, or otherwise log the input prompt 402(j), the coarse generative output 404(j), and the feedback indicator 406(j) in the prompt-output history 304. Note that, prior to the initial, beginning, or chronologically first drafting iteration, the drafting component 206 can initialize the prompt-output history 304 as an empty set, and the drafting component 206 can, as described with respect to FIG. 5, incrementally update or enlarge the prompt-output history 304 during each drafting iteration.

Furthermore, note how time can be consumed during the drafting iteration 302(j). In particular, time can be consumed during provision of the input prompt 402(j) by the user 110, during execution of the client-side generative AI model 104 on the input prompt 402(j), during rendition or play-back of the coarse generative output 404(j), during provision of the feedback indicator 406(j) by the user 110, and during updating of the prompt-output history 304. Provision of the input prompt 402(j), rendition or play-back of the coarse generative output 404(j), and provision of the feedback indicator 406(j) can all be considered as being part of a subjective workflow of the user 110 rather than interrupting that subjective workflow. Although updating of the prompt-output history 304 can be not part of that subjective workflow (e.g., the user 110 can have to wait during such updating), such updating can be mere write operations that consume a negligible amount of time as to be imperceptible to the user 110 (e.g., can consume mere milliseconds). Now, execution of the client-side generative AI model 104 on the input prompt 402(j) can be considered as not being part of the subjective workflow of the user 110 (e.g., the user 110 can have to wait during such execution), and such execution can consume a non-negligible amount of time. However, as explained above, the client-side generative AI model 104 can be configured to synthesize content having a sub-threshold quality or fidelity, and such sub-threshold quality or fidelity can allow or otherwise cause the client-side generative AI model 104 to consume very little time during execution on the input prompt 402(j). Indeed, in some cases, the client-side generative AI model 104 can consume on the order of one or two seconds, or even less, when executing on the input prompt 402(j). Such small inferencing time, even when accumulated over repeated drafting iterations, can be considered as being a commensurately small, and thus not frustrating, interruption to the subjective workflow of the user 110.

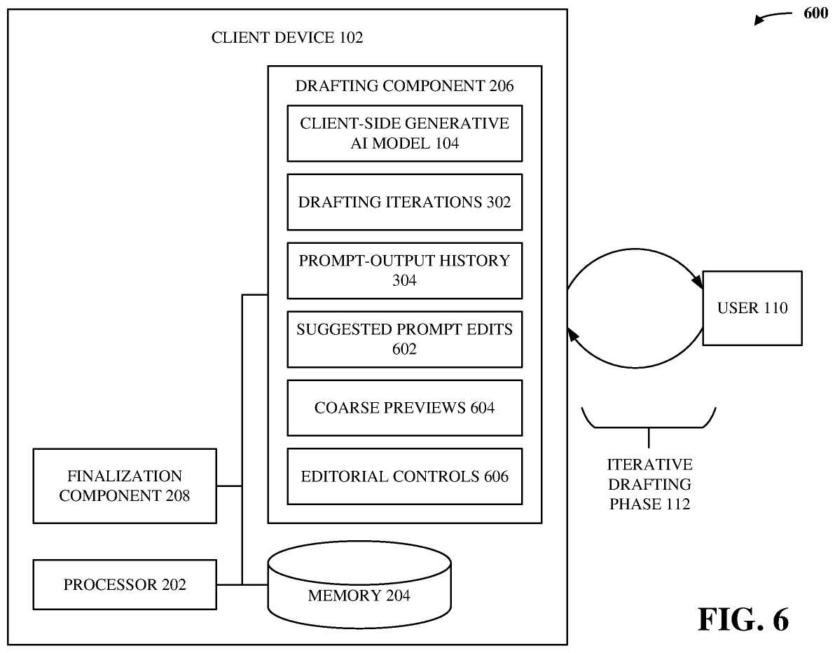

FIG. 6 illustrates an example, non-limiting block diagram 600 of the client device 102 in accordance with one or more embodiments described herein. As shown, the block diagram 600 can, in some cases, comprise the same components as the block diagram 300, and can further comprise one or more suggested prompt edits 602, one or more coarse previews 604, or one or more editorial controls 606.

In various embodiments, during any of the set of drafting iterations 302, the drafting component 206 can electronically generate the one or more suggested prompt edits 602. As mentioned above, the user 110 can provide an original input prompt during the chronologically first drafting iteration (e.g., during 302(1)),and the user 110 can instead provide edited versions of that original input prompt during successive or follow-on drafting iterations. In various aspects, the drafting component 206 can implement any suitable machine learning or artificial intelligence capabilities (e.g., neural networks, Bayesian networks, tree models, regression models) which can progressively learn which types of edits the user 110 has commonly or frequently made in the past. Accordingly, the drafting component 206 can leverage such machine learning or artificial intelligence capabilities during any of the set of drafting iterations 302 so as to suggest or recommend edits that the user 110 might be interested in making. In various cases, such suggested or recommended edits can be referred to as the one or more suggested prompt edits 602.

As a non-limiting example, suppose that an input prompt is a textual description provided by the user 110. Furthermore, suppose that the user 110 has, in the past, commonly or frequently edited their input prompts to include a particular textual term or phrase. In such case, the drafting component 206 can learn or recognize such particular textual term or phrase via any suitable machine learning or artificial intelligence capabilities. Accordingly, if the user 110 provides a given input prompt that lacks such particular textual term or phrase, the drafting component 206 can suggest or recommend to the user 110 that the given input prompt be edited to include such particular textual term or phrase.

As another non-limiting example, suppose that an input prompt is an image provided by the user 110. Moreover, suppose that the user 110 has, in the past, commonly or frequently applied a specific augmented reality filter to their input prompts. In such case, the drafting component 206 can learn or recognize such particular augmented reality filter via any suitable machine learning or artificial intelligence capabilities. Accordingly, if the user 110 provides a given input prompt to which such particular augmented reality filter has not been applied, the drafting component 206 can suggest or recommend to the user 110 that such particular augmented reality filter be applied to the given input prompt.

Thus, in various aspects, the drafting component 206 can, during any of the set of drafting iterations 302, electronically generate the one or more suggested prompt edits 602, based on having learned from historical editing behavior of the user 110. In various cases, the drafting component 206 can electronically present (e.g., via rendition on a computer screen or monitor of the client device 102) the one or more suggested prompt edits 602 to the user 110 for selection. Accordingly, if the user 110 so desires, the user 110 can select (e.g., invoke, click on) any of the one or more suggested prompt edits 602 during any of the set of drafting iterations 302.

In various embodiments in which the drafting component 206 generates the one or more suggested prompt edits 602, the drafting component 206 can, in various aspects, electronically generate the one or more coarse previews 604. More specifically, as mentioned above, the one or more suggested prompt edits 602 can be considered as edits to input prompts that the drafting component 206 has predicted or inferred that the user 110 might be interested in making during any given drafting iteration. In various instances, not only can the drafting component 206 recommend such edits, but the drafting component 206 can, in various cases, also provide respective previews of what coarse generative outputs would look, sound, or be like if such recommended edits were adopted or selected by the user 110. In various aspects, such previews can be considered as the one or more coarse previews 604.

As a non-limiting example, suppose that an input prompt is a textual description provided by the user 110, suppose that the drafting component 206 has recommended or suggested that a particular term or phrase be added to that input prompt, and suppose that the user 110 has not yet selected or adopted that particular term or phase. In various aspects, the drafting component 206 can create a version of that input prompt as edited with that particular term or phrase, and the drafting component 206 can execute the client-side generative AI model 104 on that version of the input prompt, thereby yielding some coarse generative output. In various instances, the drafting component 206 can accordingly render or play that coarse generative output on the client device 102, so as to show the user 110 what effect that particular term or phrase would have on content synthesis. In other words, the drafting component 206 can be considered as giving the user 110 a preview or sneak-peak at what coarse generative content would be synthesized if the input prompt were edited as suggested.

As another non-limiting example, suppose that an input prompt is an image provided by the user 110, suppose that the drafting component 206 has recommended or suggested that a particular augmented reality filter be added to that input prompt, and suppose that the user 110 has not yet selected or adopted that particular augmented reality filter. In various aspects, the drafting component 206 can create a version of that input prompt as edited with that particular augmented reality filter, and the drafting component 206 can execute the client-side generative AI model 104 on that version of the input prompt, thereby yielding some coarse generative output. In various instances, the drafting component 206 can accordingly render or play that coarse generative output on the client device 102, so as to show the user 110 what effect that particular augmented reality filter would have on content synthesis. Again, the drafting component 206 can be considered as giving the user 110 a preview or sneak-peak at what coarse generative content would be synthesized if the input prompt were edited as suggested.

In various embodiments, the drafting component 206 can electronically present (e.g., on a computer screen or monitor of the client device 102) the one or more editorial controls 606 to the user 110. In various aspects, an editorial control can be any suitable preset or preconfigured electronic action that can be invoked (e.g., clicked) by the user 110 in order to edit or otherwise alter an input prompt. As a non-limiting example, the user 110 can make any suitable edit to an input prompt, and an editorial control can be an undo button that undoes that edit (e.g., that causes the input prompt to revert back to its pre-edit state). As another non-limiting example, an editorial control can be a redo button that redoes a most recently undone edit (e.g., that causes an input prompt currently in a pre-edit state to revert back to its post-edit state). As yet another non-limiting example, an input prompt can be an image, and an editorial control can be any suitable functionality that can enable the user 110 to crop or otherwise distort that image. As still another non-limiting example, an input prompt can be an image, and an editorial control can be any suitable functionality that can enable the user 110 to draw on or otherwise mark-up that image. As even another non-limiting example, an input prompt can be a video or a sound recording, and an editorial control can be any suitable functionality that can enable the user 110 to speed-up or slow-down that video or sound recording. In any case, the user 110 can utilize or engage with the one or more editorial controls 606 so as to craft or adjust input prompts as the user 110 desires.

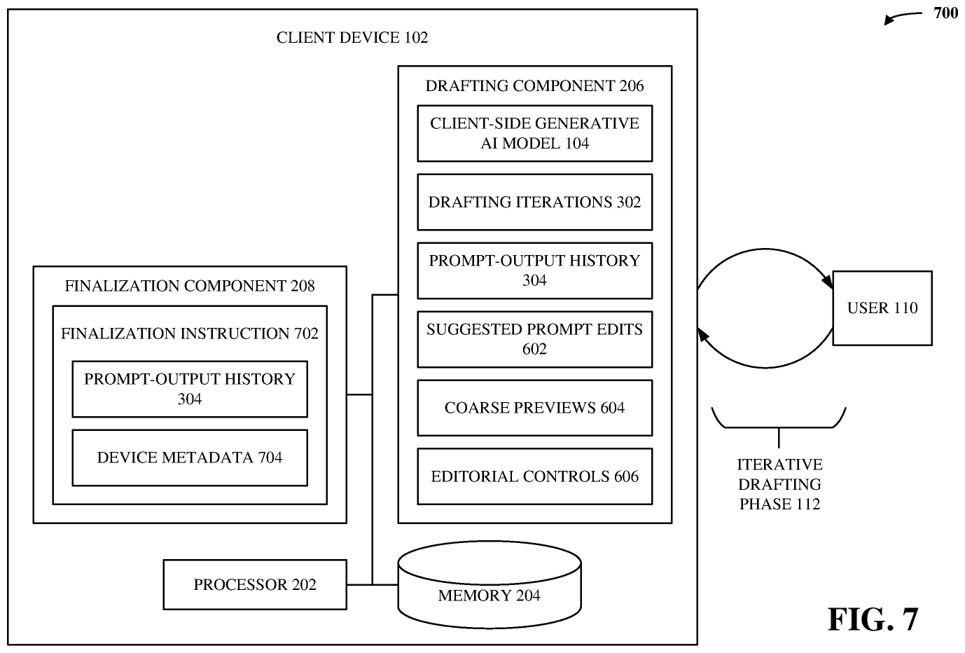

FIG. 7 illustrates an example, non-limiting block diagram 700 of the client device 102 in accordance with one or more embodiments described herein. As shown, the block diagram 700 can, in some cases, include the same components as the block diagram 600, and can further include a finalization instruction 702.

In various embodiments, the user 110 can indicate or otherwise signal to the drafting component 206 (e.g., via any suitable interface of the client device 102) that no more drafting iterations are to be performed during the iterative drafting phase 112. That is, the user 110 can decide to end, terminate, or otherwise finish the iterative drafting phase 112. In response, the finalization component 208 can initiate or begin the finalization phase 114 by electronically generating a finalization instruction 702.

In various aspects, the finalization instruction 702 can be any suitable electronic data having any suitable format, size, or dimensionality. In various instances, the finalization instruction 702 can contain as a payload the prompt-output history 304 or any suitable portion thereof. That is, the finalization instruction 702 can, in some cases, contain or include an entirety of the prompt-output history 304, and the finalization instruction 702 can, in other cases, contain or include any suitable subset of the prompt-output history 304.

In various aspects, as shown, the finalization instruction 702 can comprise device metadata 704. In various instances, the device metadata 704 can be or otherwise include any suitable metadata that can pertain to the client device 102 or to the prompt-output history 304.

As a non-limiting example, the device metadata 704 can be or otherwise include a timestamp associated with the prompt-output history 304. In various cases, the timestamp can indicate, convey, or otherwise represent a time or date at which the client device 102 produced or generated the prompt-output history 304. In various instances, the timestamp can be recited according to any suitable level of granularity (e.g., can specify year, month, day, hour, minute, or second at which the prompt-output history 304 was created).

As another non-limiting example, the device metadata 704 can be or otherwise include a geolocation stamp (e.g., a geostamp) associated with the prompt-output history 304. In various cases, the geolocation stamp can indicate, convey, or otherwise represent a geographical location at which the client device 102 produced or generated the prompt-output history 304. In various instances, the geolocation stamp can be recited according to any suitable level of granularity (e.g., can specify the continent, country, state/province, city, street, building number, latitude, longitude, or elevation at which the prompt-output history 304 was created).

As yet another non-limiting example, the device metadata 704 can be or otherwise include a modality indicator of the client device 102. In some cases, the modality indicator can indicate, convey, or otherwise represent what type of computing device the client device 102 is (e.g., a desktop computer, a laptop computer, a smart phone, a smart watch, smart glasses, a vehicle-integrated computer). In other cases, the modality indicator can indicate, convey, or otherwise represent what computing capabilities the client device 102 has (e.g., how much computer memory, how much computer processing capacity, how many cameras, how many speakers, how many microphones, what operating system version, what screen resolution).

In any case, the client device 102 can electronically transmit the finalization instruction 702 to the server device 106. In various aspects, the finalization instruction 702 can be considered as an electronic request commanding that the server device 106 synthesize, via the server-side generative AI model 108, a fine generative output for the user 110, based on the prompt-output history 304 or based on the device metadata 704.

Note that, in various aspects, the drafting component 206 can perform or facilitate the set of drafting iterations 302 in a temporally contiguous or continuous fashion. That is, the user 110 can participate in all n of the set of drafting iterations 302 in a single work session or sit-down session with the client device 102, without rest periods or break periods in between various consecutive drafting iterations. However, this is a mere non-limiting example. In other cases, the drafting component 206 can perform or facilitate the set of drafting iterations 302 in a temporally non-contiguous or non-continuous fashion. That is, the user 110 can take rest periods or break periods in between various consecutive drafting iterations. As a non-limiting example, the user 110 can participate in the first k drafting iterations, for any suitable positive integer k<n, during a first work session or sit-down session with the client device 102; the user 110 can then take a rest period or a break period of any suitable amount of time; and the user 110 can, after that rest period or break period elapses, participate in the remaining n-k drafting iterations during a second work session or sit-down session with the client device 102. In other words, the drafting component 206 can pause the set of drafting iterations 302 as the user 110 desires and can resume the set of drafting iterations 302 at a later time as the user 110 desires.

FIG. 8 illustrates an example, non-limiting block diagram 800 of the server device 106 in accordance with one or more embodiments described herein.

In various embodiments, the server device 106 can comprise a processor 802 (e.g., computer processing unit, microprocessor) and a non-transitory computer-readable memory 804 that is operably or operatively or communicatively connected or coupled to the processor 802. The non-transitory computer-readable memory 804 can store computer-executable instructions which, upon execution by the processor 802, can cause the processor 802 or other components of the server device 106 (e.g., access component 806, model component 808) to perform one or more acts. In various embodiments, the non-transitory computer-readable memory 804 can store computer-executable components (e.g., access component 806, model component 808), and the processor 802 can execute the computer-executable components.

In various embodiments, as shown, the server device 106 can comprise an access component 806. In various aspects, as described herein, the access component 806 can electronically receive the finalization instruction 702 from the client device 102.

In various embodiments, as shown, the server device 106 can comprise a model component 808. In various instances, the model component 808 can electronically host, electronically store, electronically maintain, or otherwise electronically control the server-side generative AI model 108. In various cases, as described herein, the model component 808 can leverage the server-side generative AI model 108 to synthesize a fine generative output for the user 110, based on the finalization instruction 702.

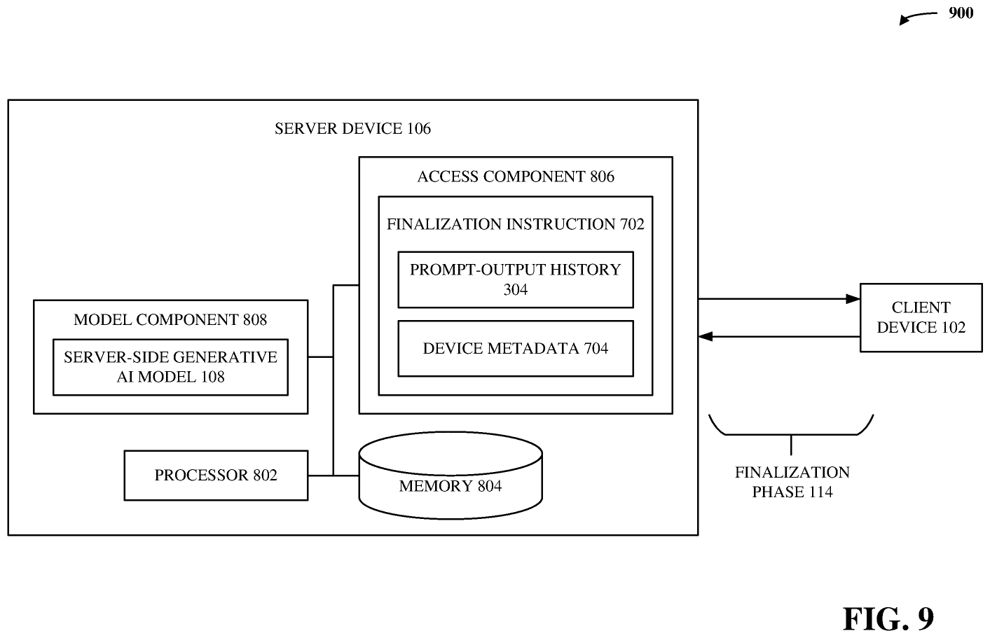

FIG. 9 illustrates an example, non-limiting block diagram 900 of the server device 106 in accordance with one or more embodiments described herein. As shown, the block diagram 900 can, in some cases, include the same components as the block diagram 800, and can further include the finalization instruction 702.

In various embodiments, during the finalization phase 114, the access component 806 can electronically receive or otherwise electronically access the finalization instruction 702. In various instances, the access component 806 can electronically retrieve the finalization instruction 702 from the client device 102. In other instances, the access component 806 can electronically retrieve the finalization instruction 702 from any suitable centralized or decentralized data structures (not shown). In any case, the access component 806 can electronically obtain or access the finalization instruction 702, such that other components of the server device 106 can electronically interact with (e.g., read, write, edit, copy, manipulate) the finalization instruction 702.

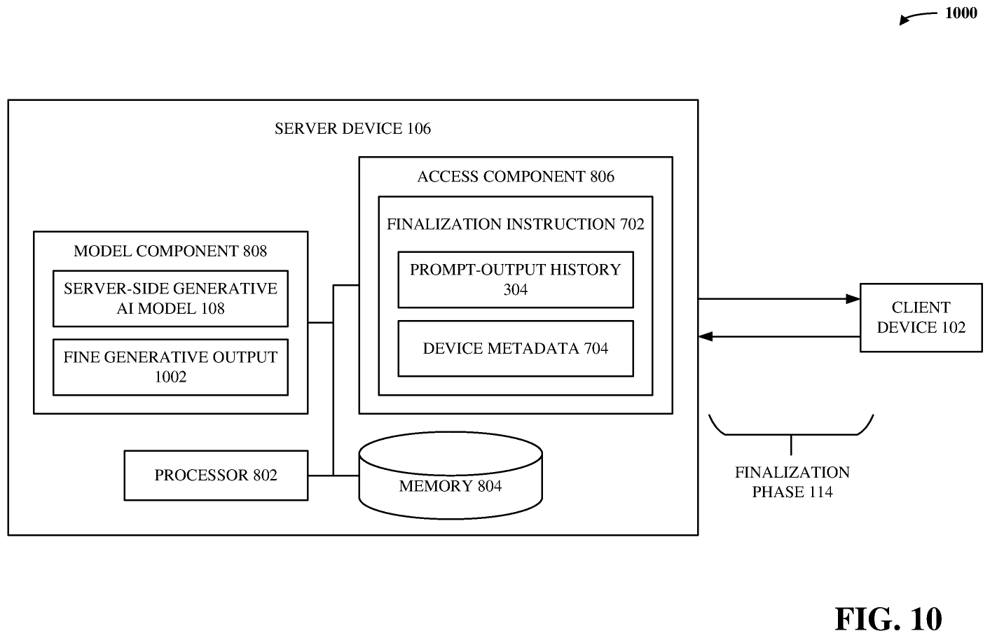

FIG. 10 illustrates an example, non-limiting block diagram 1000 of the server device 106 in accordance with one or more embodiments described herein. As shown, the block diagram 1000 can, in some cases, include the same components as the block diagram 900, and can further include a fine generative output 1002.

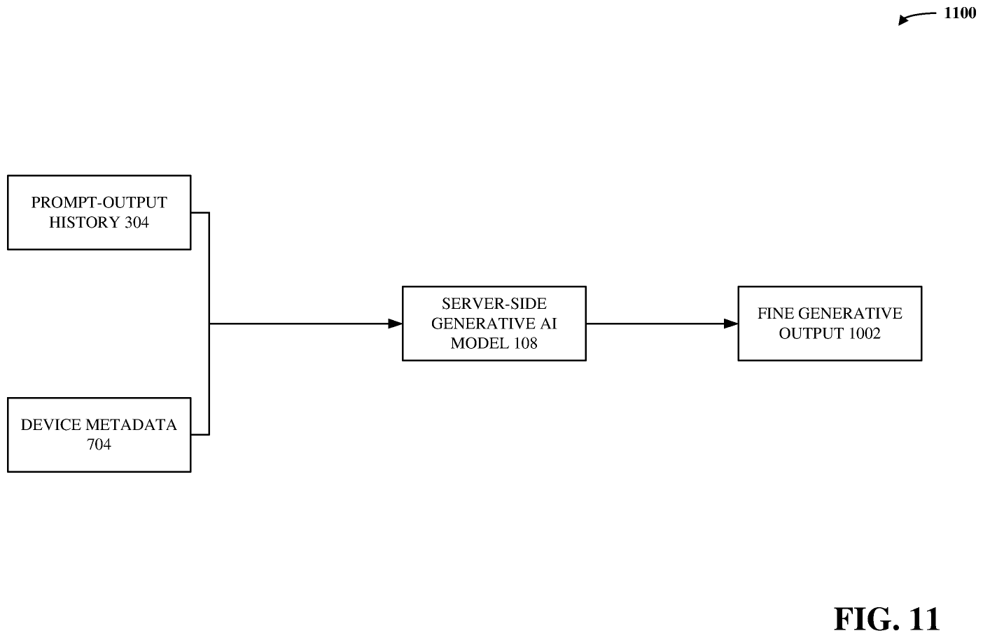

In various aspects, the model component 808 can electronically synthesize, via the server-side generative AI model 108, the fine generative output 1002 based on the finalization instruction 702. Various non-limiting aspects are described with respect to FIG. 11.

FIG. 11 illustrates an example, non-limiting block diagram 1100 showing how the fine generative output 1002 can be synthesized in accordance with one or more embodiments described herein.

In various aspects, as mentioned above, the finalization instruction 702 can comprise the prompt-output history 304 (or a portion thereof) and the device metadata 704. In various instances, the model component 808 can electronically execute the server-side generative AI model 108 on the prompt-output history 304 (or whatever portion thereof was included in the finalization instruction 702) and on the device metadata 704. In various cases, such execution can cause the server-side generative AI model 108 to synthesize the fine generative output 1002. More specifically, the model component 808 can concatenate the prompt-output history 304 with the device metadata 704, and the model component 808 can feed or otherwise pass that concatenation to an input layer of the server-side generative AI model 108. In various instances, that concatenation can complete a forward pass through one or more hidden layers of the server-side generative AI model 108. In various cases, an output layer of the server-side generative AI model 108 can calculate or compute the fine generative output 1002, based on activation maps generated by the one or more hidden layers of the server-side generative AI model 108.

In various aspects, the fine generative output 1002 can be considered as synthetic content (e.g., synthetic text, images, videos, or sound recordings) that is substantively consistent with whichever coarse generative outputs are indicated in the prompt-output history 304 as having been approved by the user 110 and that is substantively inconsistent with whichever coarse generative outputs are indicated in the prompt-output history 304 as having been disapproved by the user 110. In other words, the approved coarse generative outputs of the prompt-output history 304 can be interpreted by the server-side generative AI model 108 as positive examples of synthetic content that should be emulated, whereas the disapproved coarse generative outputs of the prompt-output history 304 can instead be interpreted by the server-side generative AI model 108 as negative examples of synthetic content that should be avoided. Accordingly, the server-side generative AI model 108 can cause the fine generative output 1002 to be more similar (e.g., as measured via any suitable metric such as cosine similarity, Euclidean distance, or cross-entropy error) to the approved coarse generative outputs specified in the prompt-output history 304 and to be less similar to the disapproved coarse generative outputs specified in the prompt-output history 304.

Furthermore, in various aspects, the fine generative output 1002 can exhibit any suitable supra-threshold quality or fidelity (e.g., supra-threshold visual, literary, or aural qualities or fidelities). Accordingly, the fine generative output 1002 can be considered as an improved, higher-quality, more-detailed version of the approved coarse generative outputs specified in the prompt-output history 304.

Further still, because the server-side generative AI model 108 can receive the device metadata 704 as input in addition to the prompt-output history 304, the fine generative output 1002 can be considered as also being a function of the device metadata 704. In other words, various characteristics or attributes of the fine generative output 1002 can change depending upon the device metadata 704 (e.g., depending upon the modality of the client device 102, depending upon the time or date at which the prompt-output history 304 was generated, depending upon the geographic location at which the prompt-output history 304 was generated).

As mentioned above, the server-side generative AI model 108 can be configured to synthesize content having a supra-threshold quality or fidelity. In various aspects, such supra-threshold quality or fidelity can cause the server-side generative AI model 108 to consume a sizeable amount of time during execution on the prompt-output history 304 and on the device metadata 704. Indeed, in some cases, the server-side generative AI model 108 can consume on the order of 30 seconds, 45 seconds, or even longer, when executing on the prompt-output history 304 and on the device metadata 704. However, the user 110 can have iterated with the client-side generative AI model 104 and can refrain from iterating with the server-side generative AI model 108. Thus, there can be no accumulation in such sizeable inferencing time. This can amount to less of a frustrating interruption to the subjective workflow of the user 110, as compared to various existing techniques.

Note that, in various aspects, the size or length of the prompt-output history 304 can be variable (e.g., can depend upon how many drafting iterations the user 110 desires to perform). In various instances, the server-side generative AI model 108 can be configured to receive as input electronic data having no more than some maximum size or length. In some cases, the prompt-output history 304 and the device metadata 704 can, when concatenated together, exhibit that maximum size or length. In such case, the server-side generative AI model 108 can be executed on that concatenation without issue. In other cases, the prompt-output history 304 and the device metadata 704 can, when concatenated together, exhibit a size or length that is smaller than that maximum size or length. In such case, any suitable dummy or filler variables (e.g., zeros) can be used to lengthen that concatenation, such that the lengthened concatenation now exhibits that maximum size or length. Accordingly, the server-side generative AI model 108 can be executed on that lengthened concatenation without issue. In yet other cases, the prompt-output history 304 and the device metadata 704 can, when concatenated together, exhibit a size or length that is greater than that maximum size or length. In such case, that concatenation can be truncated, such that the truncated concatenation now exhibits that maximum size or length. Accordingly, the server-side generative AI model 108 can be executed on that truncated concatenation without issue.

In various aspects, during the finalization phase 114, the model component 808 can electronically transmit the fine generative output 1002 back to the finalization component 208 of the client device 102. In various instances, the finalization component 208 can electronically render or play (e.g., via a computer screen or speaker of the client device 102) the fine generative output 1002 so as to be seen or heard by the user 110.

Accordingly, as described herein, the client device 102 and the server device 106 can work together in distributed fashion to synthesize content for the user 110, without consuming excessive time and thus without excessively halting or frustrating a subjective workflow of the user 110.

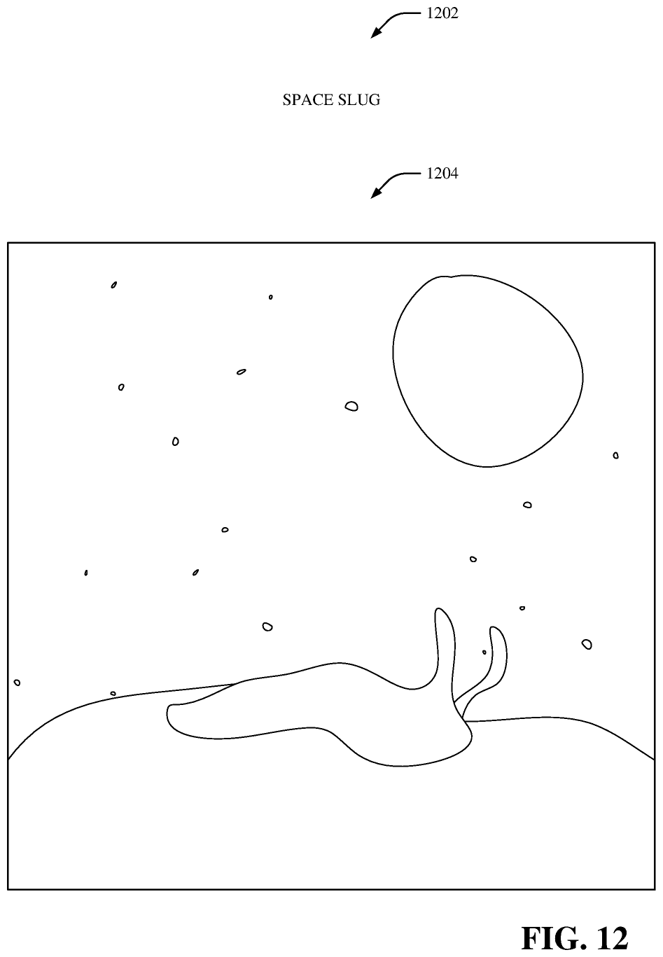

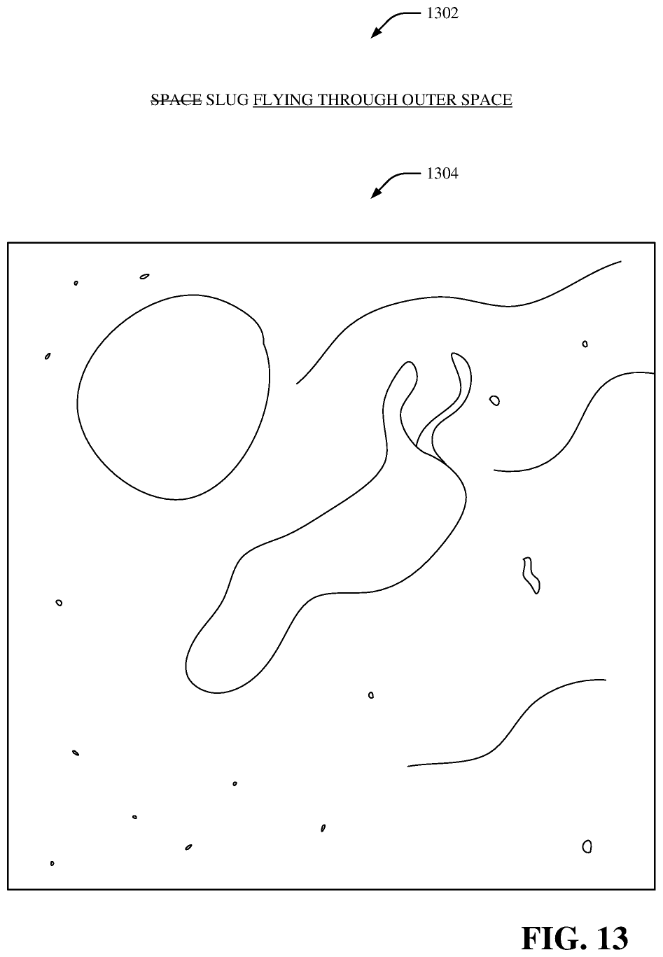

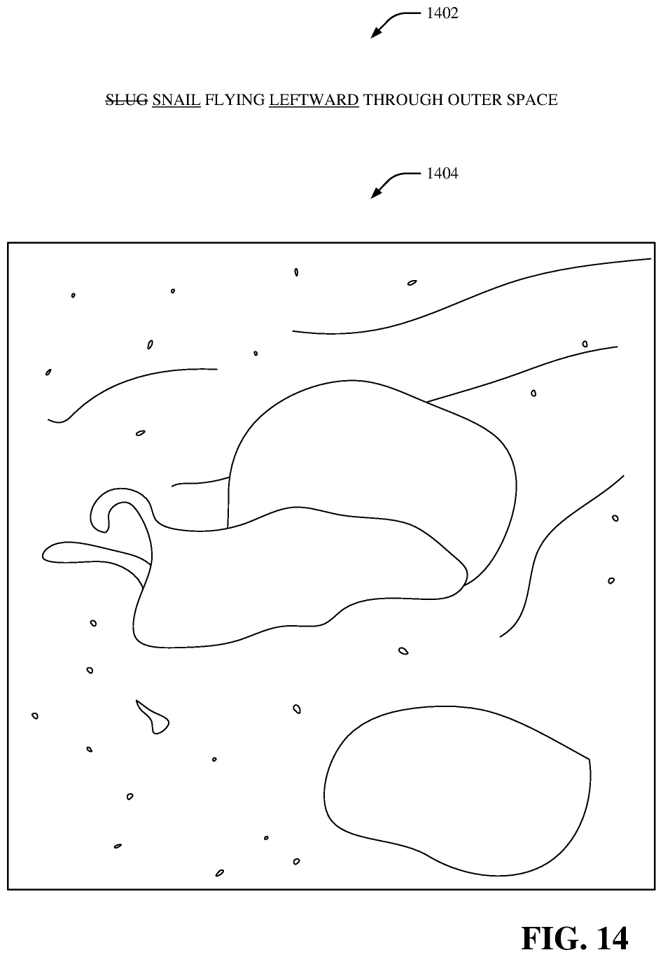

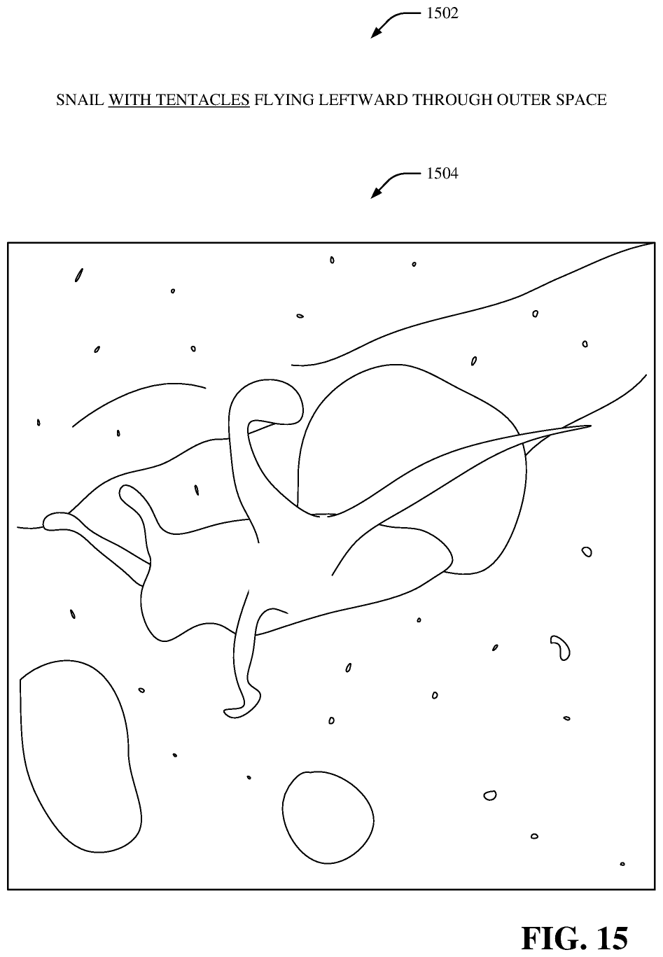

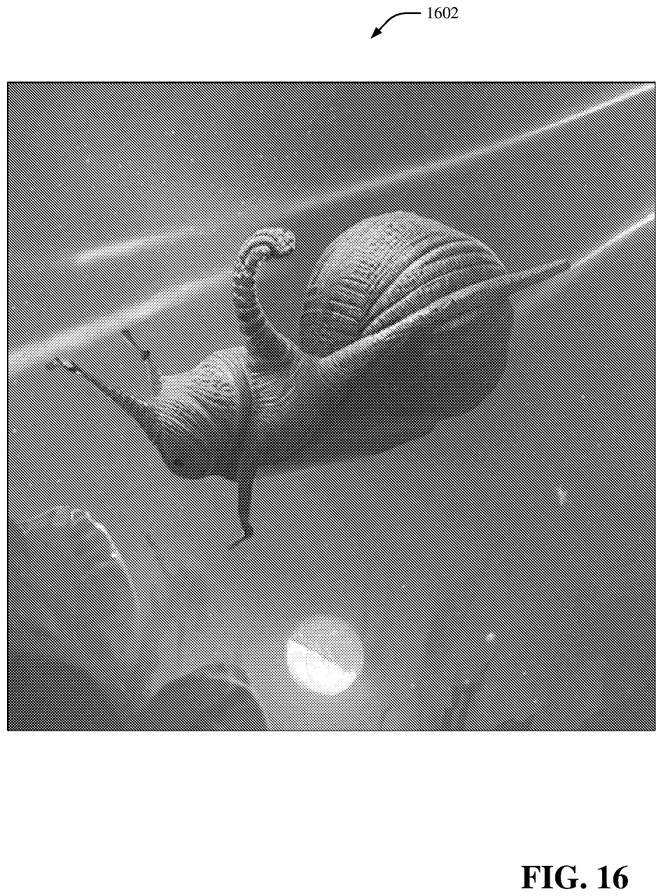

To help clarify various of the above aspects, consider the non-limiting and illustrative example discussed with respect to FIGS. 12-16. FIGS. 12-16 illustrate example, non-limiting prompts and generative outputs in accordance with one or more embodiments described herein.

In this non-limiting and illustrative example, suppose that input prompts are short textual descriptions, and suppose that generative outputs are two-dimensional images that visually portray whatever is verbally described in those textual descriptions.

Now, suppose that the user 110 desires to synthesize an image of a mollusk soaring in space amongst the stars or planets. With such an image envisioned, the user 110 can participate in the iterative drafting phase 112 with the client device 102.

During a first drafting iteration, the user 110 can provide a first input prompt 1202 to the client device 102. As shown, the first input prompt 1202 can be a textual description that recites “space slug”. This can be considered as a first attempt by the user 110 to obtain the synthetic content they envision or desire. As described above, the client device 102 can execute the client-side generative AI model 104 on the first input prompt 1202, and such execution can cause the client-side generative AI model 104 to synthesize a first coarse generative output 1204. As shown, the first coarse generative output 1204 can be an image that depicts what appears to be a slug slithering on a surface beneath a sky filled with stars, planets, or other celestial bodies. Moreover, note that the first coarse generative output 1204 can be considered as possessing a low visual quality. Indeed, the first coarse generative output 1204 has a rather low spatial resolution, lacks graduated visual shading, and is composed of interior-less shape outlines (e.g., an outline of a slug is shown, but that outline contains no interior detail of the slug). The user 110 can decide that the first coarse generative output 1204 does not comport or is otherwise inconsistent with what they envision or desire (which might change across drafting iterations). Accordingly, the user 110 can disapprove or reject the first coarse generative output 1204. So, a second drafting iteration can commence.

During the second drafting iteration, the user 110 can provide a second input prompt 1302 to the client device 102. As shown, the second input prompt 1302 can be an edited version of the first input prompt 1202 and can recite “slug flying through outer space”. This can be considered as an updated attempt by the user 110 to obtain the synthetic content they envision or desire. As described above, the client device 102 can execute the client-side generative AI model 104 on the second input prompt 1302, and such execution can cause the client-side generative AI model 104 to synthesize a second coarse generative output 1304. As shown, the second coarse generative output 1304 can be an image that depicts what appears to be a slug flying or floating through space with stars, planets, or other celestial bodies in the background. Again, note that the second coarse generative output 1304 can be considered as possessing a low visual quality (e.g., has a rather low spatial resolution, lacks graduated visual shading, and is composed of interior-less shape outlines). The user 110 can again decide that the second coarse generative output 1304 does not comport or is otherwise inconsistent with what they envision or desire (which might change across drafting iterations). Accordingly, the user 110 can disapprove or reject the second coarse generative output 1304. So, a third drafting iteration can commence.

During the third drafting iteration, the user 110 can provide a third input prompt 1402 to the client device 102. As shown, the third input prompt 1402 can be an edited version of the second input prompt 1302 and can recite “snail flying leftward through outer space”. This can be considered as still another updated attempt by the user 110 to obtain the synthetic content they envision or desire. As described above, the client device 102 can execute the client-side generative AI model 104 on the third input prompt 1402, and such execution can cause the client-side generative AI model 104 to synthesize a third coarse generative output 1404. As shown, the third coarse generative output 1404 can be an image that depicts what appears to be a snail, no longer a slug, flying or floating through space in a leftward direction with stars, planets, or other celestial bodies in the background. Once again, note that the third coarse generative output 1404 can be considered as possessing a low visual quality (e.g., has a rather low spatial resolution, lacks graduated visual shading, and is composed of interior-less shape outlines). Now, the user 110 can decide that the third coarse generative output 1404 does comport or is otherwise consistent with what they envision or desire (which might change across drafting iterations). Accordingly, the user 110 can approve or accept the third coarse generative output 1404. However, the user 110 can nevertheless desire to make additional changes. So, a fourth drafting iteration can commence.

During the fourth drafting iteration, the user 110 can provide a fourth input prompt 1502 to the client device 102. As shown, the fourth input prompt 1502 can be an edited version of the third input prompt 1402 and can recite “snail with tentacles flying leftward through outer space”. This can be considered as yet another updated attempt by the user 110 to obtain the synthetic content they envision or desire. As described above, the client device 102 can execute the client-side generative AI model 104 on the fourth input prompt 1502, and such execution can cause the client-side generative AI model 104 to synthesize a fourth coarse generative output 1504. As shown, the fourth coarse generative output 1504 can be an image that depicts what appears to be a snail with multiple curling tentacle protrusions flying or floating through space in a leftward direction with stars, planets, or other celestial bodies in the background. Once more, note that the fourth coarse generative output 1504 can be considered as possessing a low visual quality (e.g., has a rather low spatial resolution, lacks graduated visual shading, and is composed of interior-less shape outlines). Now, the user 110 can decide that the fourth coarse generative output 1504 does comport or is otherwise consistent with what they envision or desire. Accordingly, the user 110 can approve or accept the fourth coarse generative output 1504. Moreover, the user 110 can decide that the fourth coarse generative output 1504 is close enough to what they envision or desire. Accordingly, the user 110 can end the iterative drafting phase 112 (e.g., no further drafting iterations can commence).

At this point, the prompt-output history 304 can be considered as comprising: all four of the input prompts 1202, 1302, 1402, and 1502; all four of the coarse generative outputs 1204, 1304, 1404, and 1504; and the respective approvals or disapprovals of those four coarse generative outputs. The client device 102 can accordingly generate the finalization instruction 702 and can transmit it to the server device 106. In various aspects, the server device 106 can, as described above, execute the server-side generative AI model 108 on the prompt-output history 304 (and on the device metadata 704, if included). In various instances, such execution can yield a fine generative output 1602. As shown, the fine generative output 1602 depicts a snail with various tentacles that appears to be flying in a leftward direction through space, against a backdrop of stars, comet tails, and other celestial objects.

Note that, unlike the coarse generative outputs 1204, 1304, 1404, and 1504, the fine generative output 1602 can be considered as possessing a high visual quality. Indeed, the fine generative output 1602 has a high spatial resolution, includes graduated visual shading, and is composed of shapes with intricate interior detail.

Furthermore, note that the fine generative output 1602 can be considered as being visually or substantively consistent with the approved coarse generative outputs (e.g., 1404 and 1504) rather than with the disapproved coarse generative outputs (e.g., 1204 and 1304).

Further still, note that a significant amount of inferencing time can have been saved by synthesizing the fine generative output 1602 in a distributed fashion between the client device 102 and the server device 106. Indeed, as a non-limiting example, suppose that the client-side generative AI model 104 consumed 2 seconds per execution, and suppose that the server-side generative AI model 108 consumed 30 seconds per execution. In other words, the user 110 can have: provided the first input prompt 1202 and then waited about 2 seconds for the first coarse generative output 1204; provided the second input prompt 1302 and then waited about 2 seconds for the second coarse generative output 1304; provided the third input prompt 1402 and then waited about 2 seconds for the third coarse generative output 1404; provided the fourth input prompt 1502 and then waited about 2 seconds for the fourth coarse generative output 1504; and then waited about 30 seconds for the fine generative output 1602. This can amount to a total of about 38 seconds of inferencing time (e.g., 38 seconds of interruption of the subjective workflow of the user 110).

Contrast this with existing techniques, in which the user 110 would instead have: provided the first input prompt 1202 and then waited about 30 seconds for a fine version of the first coarse generative output 1204; provided the second input prompt 1302 and then waited about 30 seconds for a fine version of the second coarse generative output 1304; provided the third input prompt 1402 and then waited about 30 seconds for a fine version of the third coarse generative output 1404; and provided the fourth input prompt 1502 and then waited about 30 seconds for a fine version of the fourth coarse generative output 1504 (e.g., if the user 110 were satisfied with that most recent fine version, that most recent fine version could be considered as being equivalent to the fine generative output 1602). This would have instead amounted to a total of about 120 seconds of inferencing time (e.g., 120 seconds of interruption of the subjective workflow of the user 110).

Accordingly, FIGS. 12-16 help to illustrate how various embodiments described herein can reduce cumulative inferencing time and can thus correspondingly reduce frustrating interruptions of the subjective workflow of the user 110.

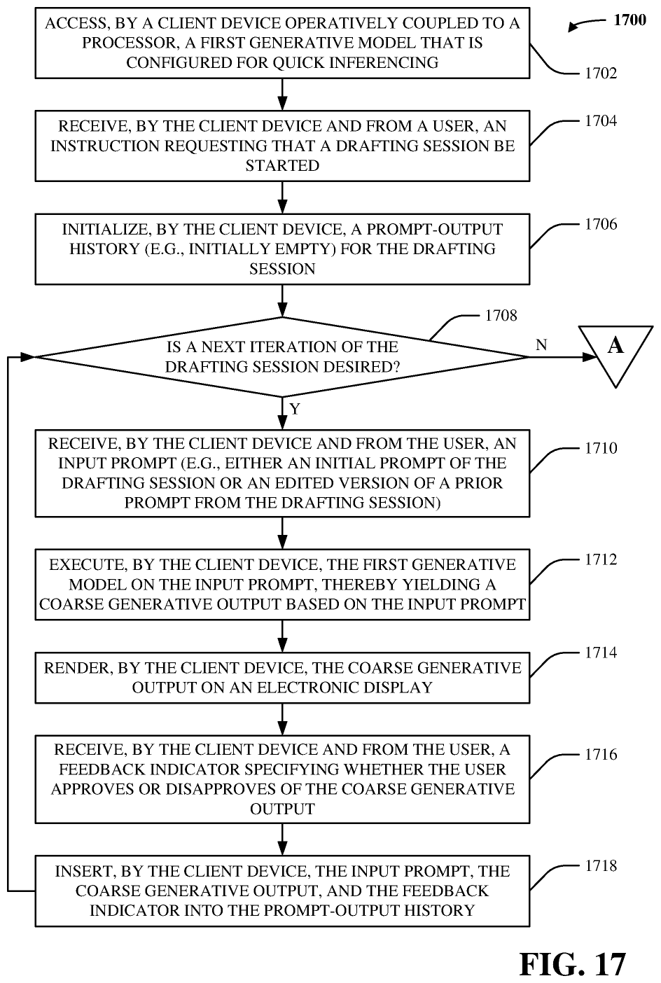

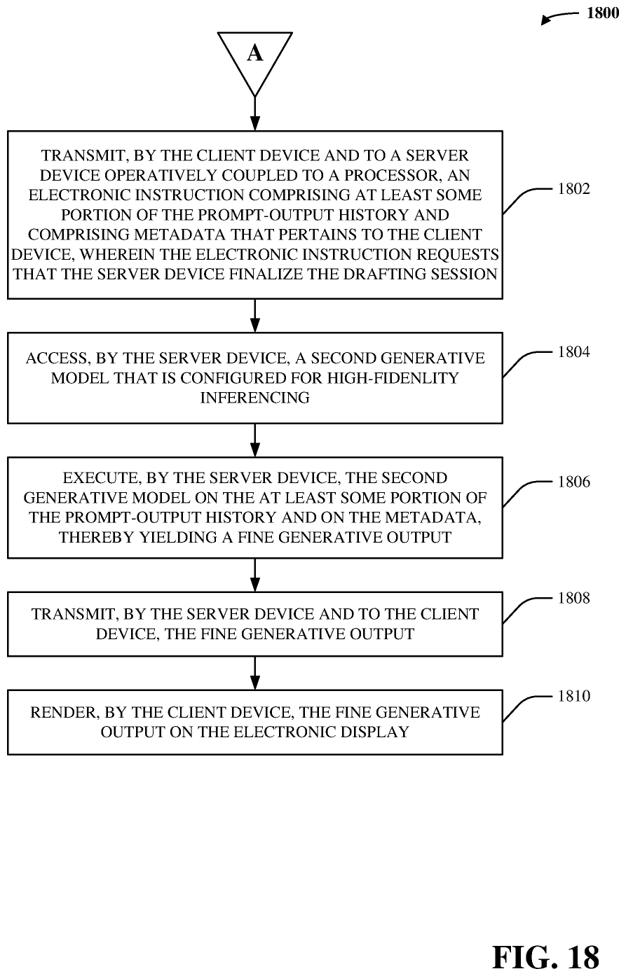

FIGS. 17-18 illustrate flow diagrams of example, non-limiting computer-implemented methods 1700 and 1800 that can facilitate distributed generative artificial intelligence for improved user workflow in accordance with one or more embodiments described herein. In various cases, the client device 102 and the server device 106 can collectively facilitate the computer-implemented methods 1700 and 1800.

First, consider FIG. 17. In various embodiments, act 1702 can include accessing, by a client device (e.g., via 206 of 102) operatively coupled to a processor (e.g., 202), a first generative model (e.g., 104) that is configured for quick inferencing.

In various aspects, act 1704 can include receiving, by the client device (e.g., via 206) and from a user (e.g., 110), an instruction requesting that a drafting session be started (e.g., the iterative drafting phase 112 and the finalization phase 114 can be collectively considered as a drafting session, and the user 110 can initiate that drafting session by interfacing with the client device 102).

In various instances, act 1706 can include initializing, by the client device (e.g., via 206), a prompt-output history (e.g., 304) for the drafting session. In various cases, the prompt-output history can be initially empty.

In various aspects, act 1708 can include determining, by the device (e.g., via 206), whether a next iteration (e.g., one of 302) of the drafting session is desired. If so (e.g., if the user desires a next drafting iteration), then the computer-implemented method 1700 can proceed to act 1710. If not (e.g., if the user does not desire a next drafting iteration), then the computer-implemented method 1700 can instead proceed to act 1802 of the computer-implemented method 1800.

In various instances, act 1710 can include receiving, by the client device (e.g., via 206) and from the user, an input prompt (e.g., 402(j)). In various cases, the input prompt can be an initial or original input prompt, or it can instead be an edited version of a prior prompt from the drafting session.

In various aspects, act 1712 can include executing, by the client device (e.g., via 206), the first generative model on the input prompt. This can yield a coarse generative output (e.g., 404(j)) that is based on the input prompt.

In various instances, act 1714 can include rendering, by the client device (e.g., via 206), the coarse generative output on an electronic display that is viewable by the user.

In various cases, act 1716 can include receiving, by the client device (e.g., via 206) and from the user, a feedback indicator (e.g., 406(j)) that can specify whether the user approves or disapproves of the coarse generative output.

In various aspects, act 1718 can include inserting, by the client device (e.g., via 206), the input prompt, the coarse generative output, and the feedback indicator into the prompt-output history. In various cases, the computer-implemented method 1700 can then proceed back to act 1708.

Now, consider FIG. 18. In various embodiments, act 1802 can include transmitting, by the client device (e.g., via 208) and to a server device (e.g., via 806 of 106) operatively coupled to a processor (e.g., 802), an electronic instruction (e.g., 702) comprising at least some portion of the prompt-output history and comprising metadata (e.g., 704) that pertains to the client device. In various cases, the electronic instruction can request that the server device finalize the drafting session for the user.

In various aspects, act 1804 can include accessing, by the server device (e.g., via 808), a second generative model (e.g., 108) that is configured for high-fidelity inferencing.

In various instances, act 1806 can include executing, by the server device (e.g., via 808), the second generative model on the at least some portion of the prompt-output history and on the metadata. In various cases, this can yield a fine generative output (e.g., 1002).

In various aspects, act 1808 can include transmitting, by the server device (e.g., via 808) and to the client device (e.g., via 208), the fine generative output.

In various instances, act 1810 can include rendering, by the client device (e.g., via 208), the fine generative output on the electronic display.

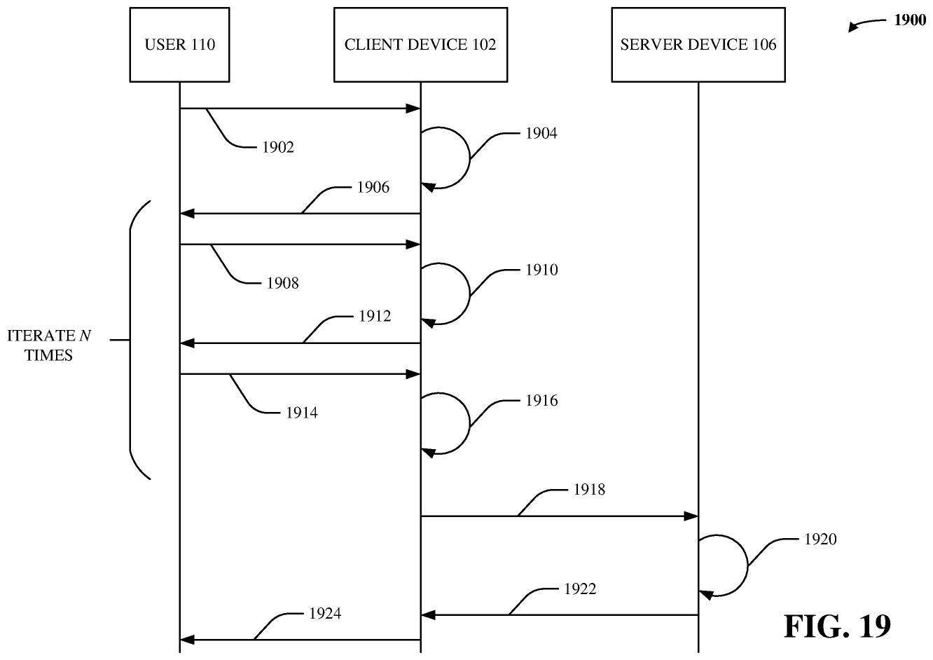

FIG. 19 illustrates an example, non-limiting communication diagram 1900 pertaining to distributed generative artificial intelligence for improved user workflow in accordance with one or more embodiments described herein.

In various embodiments, the user 110 can, at act 1902, cause the client device 102 to begin the iterative drafting phase 112.

In various aspects, the client device 102 can, at act 1904, initialize the prompt-output history 304 as an initially empty set.

In various instances, the client device 102 can, at act 1906, query the user 110 for an input prompt (e.g., 402(j)).

In various cases, the user 110 can, at act 1908, provide or otherwise supply the input prompt to the client device 102.

In various aspects, the client device 102 can, at act 1910, synthesize a coarse generative output (e.g., 404(j)) by executing the client-side generative AI model 104 on the input prompt.

In various instances, the client device 102 can, at act 1912, render or play the coarse generative output so as to be viewed or heard by the user 110.

In various cases, the user 110 can, at act 1914, provide a feedback indicator (e.g., 406(j)) to the client device 102.

In various aspects, the client device 102 can, at act 1916, insert the input prompt provided at act 1908, the coarse generative output synthesized at act 1910, and the feedback indicator provided at act 1914 into the prompt-output history 304.

Note that, in various cases, act 1906 to act 1916 can collectively be considered as forming a single drafting iteration (e.g., one of 302). Accordingly, act 1906 to act 1916 can be iterated or repeated n times (e.g., until the user 110 indicates that no further drafting iterations are to be performed).

In various instances, the client device 102 can, at act 1918, begin the finalization phase 114 by generating the finalization instruction 702, and the client device 102 can transmit the finalization instruction 702 to the server device 106.

In various cases, the server device 106 can, at act 1920, generate the fine generative output 1002 via execution of the server-side generative AI model 108.

In various aspects, the server device 106 can, at act 1922, transmit the fine generative output 1002 to the client device 102.

In various instances, the client device 102 can, at act 1924, render or play the fine generative output 1002 to be viewed or heard by the user 110.

As FIG. 19 shows, there can be a single round of communication (e.g., 1918 and 1922) between the client device 102 and the server device 106. This can reduce communication overhead, which can be beneficial for the subjective workflow of the user 110.

In order for the fine generative output 1002 to be correct or accurate (e.g., to be similar to or consistent with approved coarse generative outputs and to be dissimilar to or inconsistent with disapproved coarse generative outputs), the server-side generative AI model 108 can first undergo training. In various aspects, such training can be facilitated in supervised fashion, as described below.

Prior to beginning training, the trainable internal parameters (e.g., weight matrices, bias values, convolutional kernels) of the server-side generative AI model 108 can be randomly initialized.

In various aspects, a server-side training input and a corresponding server-side ground-truth annotation can be obtained from any suitable source (e.g., can be manually crafted by subject matter experts or technicians). In various instances, the server-side training input can be any suitable prompt-output history concatenated with any suitable device metadata. In various cases, the server-side ground-truth annotation can be considered as being whatever correct or accurate fine generative output is known or deemed to correspond to the server-side training input.

In various aspects, the server-side generative AI model 108 can be executed on the server-side training input. In various instances, this can cause the server-side generative AI model 108 to synthesize some inferencing result. More specifically, the server-side training input can be fed to the input layer of the server-side generative AI model 108. In various cases, the server-side training input can complete a forward pass through the one or more hidden layers of the server-side generative AI model 108. Accordingly, the output layer of the server-side generative AI model 108 can compute or calculate the inferencing result based on activation maps produced by the one or more hidden layers of the server-side generative AI model 108.

Note that, in various cases, the format, size, or dimensionality of the inferencing result can be controlled or otherwise determined by the number, arrangement, or sizes of neurons or other internal parameters (e.g., convolutional kernels) that are contained in or that otherwise make up the output layer of the server-side generative AI model 108. Thus, the inferencing result can be forced to have any desired format, size, or dimensionality by adding, removing, or otherwise adjusting neurons or other internal parameters to, from, or within the output layer of the server-side generative AI model 108.

In any case, the inferencing result can be considered as being whatever generative output that the server-side generative AI model 108 has synthesized based on the server-side training input. Note that, if the server-side generative AI model 108 has so far undergone no or little training, then the inferencing result can be highly inaccurate. In other words, the inferencing result can be very different from the server-side ground-truth annotation (e.g., indeed, at the beginning of training, the inferencing results synthesized by the server-side generative AI model 108 can be gibberish).

In various aspects, an error or loss (e.g., mean absolute error (MAE), mean squared error (MSE), cross-entropy) between the inferencing result and the server-side ground-truth annotation can be computed. In various instances, the trainable internal parameters of the server-side generative AI model 108 can be incrementally updated, by performing backpropagation (e.g., stochastic gradient descent) driven by the computed error or loss.

In various cases, such training procedure can be repeated for any suitable number of server-side training inputs. This can ultimately cause the trainable internal parameters of the server-side generative AI model 108 to become iteratively optimized for accurately synthesizing fine generative outputs based on inputted prompt-output histories and based on device metadata.

In various aspects, any suitable training batch sizes, any suitable training termination criterion, or any suitable error, loss, or objective function can be implemented to train the server-side generative AI model 108.

Note that supervised training of the server-side generative AI model 108 is a mere non-limiting example. In other cases, the server-side generative AI model 108 can be trained using any other training paradigm. As a non-limiting example, the server-side generative AI model 108 can be trained in unsupervised fashion. As another non-limiting example, the server-side generative AI model 108 can be trained in reinforcement learning fashion. As even another non-limiting example, the server-side generative AI model 108 can be trained in an adversarial fashion (e.g., in conjunction with a discriminator network that attempts to distinguish between real and synthetic generative outputs).

In order for the various coarse generative outputs described herein to be correct or accurate (e.g., to be substantively related to their respective input prompts), the client-side generative AI model 104 can first undergo training. In various aspects, such training can be facilitated in supervised fashion, as described below.

Prior to beginning training, the trainable internal parameters (e.g., weight matrices, bias values, convolutional kernels) of the client-side generative AI model 104 can be randomly initialized.

In various aspects, a client-side training input and a corresponding client-side ground-truth annotation can be obtained from any suitable source (e.g., can be manually crafted by subject matter experts or technicians). In various instances, the client-side training input can be any suitable input prompt. In various cases, the client-side ground-truth annotation can be considered as being whatever correct or accurate coarse generative output is known or deemed to correspond to the client-side training input.

In various aspects, the client-side generative AI model 104 can be executed on the client-side training input. In various instances, this can cause the client-side generative AI model 104 to synthesize some inferencing result. In particular, the client-side training input can be fed to the input layer of the client-side generative AI model 104. In various cases, the client-side training input can complete a forward pass through the one or more hidden layers of the client-side generative AI model 104. Accordingly, the output layer of the client-side generative AI model 104 can compute or calculate the inferencing result based on activation maps produced by the one or more hidden layers of the client-side generative AI model 104.

Note that, in various cases, the format, size, or dimensionality of the inferencing result can be controlled or otherwise determined by the number, arrangement, or sizes of neurons or other internal parameters (e.g., convolutional kernels) that are contained in or that otherwise make up the output layer of the client-side generative AI model 104. So, the inferencing result can be forced to have any desired format, size, or dimensionality by adding, removing, or otherwise adjusting neurons or other internal parameters to, from, or within the output layer of the client-side generative AI model 104.

In any case, the inferencing result can be considered as being whatever generative output that the client-side generative AI model 104 has synthesized based on the client-side training input. Note that, if the client-side generative AI model 104 has so far undergone no or little training, then the inferencing result can be highly inaccurate. That is, the inferencing result can be very different from the client-side ground-truth annotation (e.g., in fact, at the beginning of training, the inferencing results synthesized by the client-side generative AI model 104 can be gibberish).

In various aspects, an error or loss (e.g., MAE, MSE, cross-entropy) between the inferencing result and the client-side ground-truth annotation can be computed. In various instances, the trainable internal parameters of the client-side generative AI model 104 can be incrementally updated, by performing backpropagation (e.g., stochastic gradient descent) driven by the computed error or loss.

In various cases, such training procedure can be repeated for any suitable number of client-side training inputs. This can ultimately cause the trainable internal parameters of the client-side generative AI model 104 to become iteratively optimized for accurately synthesizing coarse generative outputs based on input prompts. In various aspects, any suitable training batch sizes, any suitable training termination criterion, or any suitable error, loss, or objective function can be implemented to train the client-side generative AI model 104.

Just as above, note that supervised training of the client-side generative AI model 104 is a mere non-limiting example. In other cases, the client-side generative AI model 104 can be trained using any other training paradigm (e.g., unsupervised training, reinforcement learning, adversarial training).

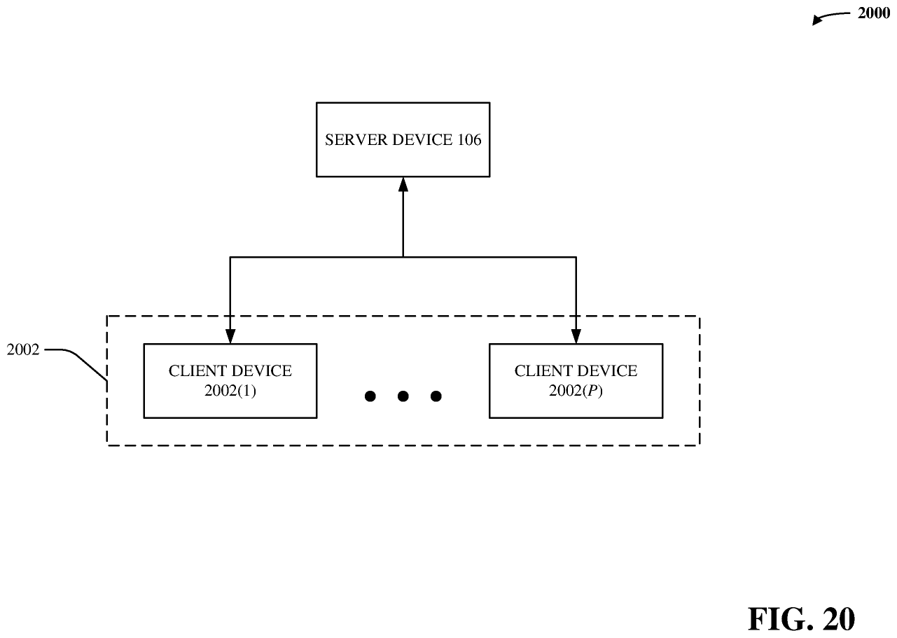

Although the herein disclosure has mainly described various embodiments as implementing a single instance of the client device 102, this is a mere non-limiting example for case of illustration and explanation. In various aspects, there can be any suitable number of client devices in electronic communication with the server device 106. Various non-limiting aspects are described with respect to FIG. 20.

FIG. 20 illustrates an example, non-limiting block diagram 2000 showing how the server device 106 can interface with a plurality of client devices in accordance with one or more embodiments described herein.

In various embodiments, the server device 106 can be electronically integrated, via any suitable wired or wireless electronic connections, with a plurality of client devices 2002. In various aspects, the plurality of client devices 2002 can comprise p client devices for any suitable positive integer p>1: a client device 2002(1) to a client device 2002(p). In various instances, each of the plurality of client devices 2002 can be as the client device 102. That is, each of the plurality of client devices 2002 can: be any suitable computing device (e.g., desktop computer, laptop computer, smart phone, smart watch); can electronically host its own client-side generative AI model (e.g., its own instance of 104); and can facilitate iterative drafting phases with its own respective user.

In various cases, each of the plurality of client devices 2002 can have a client-side generative AI model that is customized according to the preferences of its respective user. As a non-limiting example, the client device 2002(1) can have a first client-side generative AI model and a first user. Suppose that the first user desires to perform drafting iterations with black-and-white images that include graduated visual shading. In such case, the first client-side generative AI model can be trained or configured to synthesize coarse generative outputs that are colorless with graduated visual shading. As another non-limiting example, the client device 2002(p) can have a p-th client-side generative AI model and a p-th user. Unlike the first user of the client device 2002(1), the p-th user of the client device 2002(p) can desire to perform drafting iterations with colored images that lack graduated visual shading. So, unlike the first client-side generative AI model, the p-th client-side generative AI model can be trained or configured to synthesize coarse generative outputs that are colored without graduated visual shading. In this way, each client-side generative AI model can be customized or optimized according to the preferences of its respective user (or according to the processing and memory capabilities of its respective client device).

As mentioned above, the client device 102 can learn prompt edits that the user 110 commonly or frequently makes. In various cases, each of the plurality of client devices 2002 can likewise learn prompt edits that its respective user commonly or frequently makes. In various aspects, each of the plurality of client devices 2002 can periodically or aperiodically share those learned prompt edits with the server device 106. In various instances, the server device 106 can aggregate all of those learned prompt edits together and can share such aggregation with each of the plurality of client devices 2002. In this way, each individual client device can become aware of common or frequent edits that other users make, and so that client device can accordingly suggest or recommend those common or frequent edits to its own user. As a non-limiting example, aggregation of prompt edits by the server device 106 can inform the client device 2002(1) of prompt edits that the p-th user of the client device 2002(p) commonly or frequently makes. In some instances, the client device 2002(1) can accordingly recommend or suggest one or more of those edits to the first user of the client device 2002(1), notwithstanding that the first user of the client device 2002(1) may not have commonly or frequently made such edits in the past. In other words, group learning can be facilitated over the plurality of client device 2002.

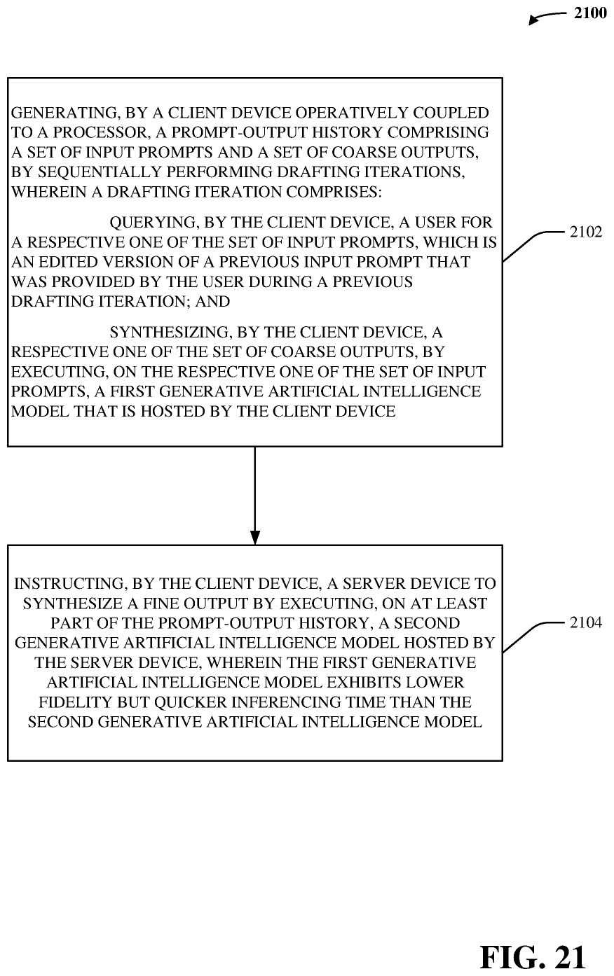

FIG. 21 illustrates a flow diagram of an example, non-limiting computer-implemented method 2100 that can facilitate client-side distributed generative artificial intelligence for improved user workflow in accordance with one or more embodiments described herein. In various cases, the client device 102 can facilitate the computer-implemented method 2100.

In various embodiments, act 2102 can include generating, by a client device (e.g., via 206 of 102) operatively coupled to a processor (e.g., 202), a prompt-output history (e.g., 304) comprising a set of input prompts (e.g., 402) and a set of coarse outputs (e.g., 404), by sequentially performing a set of drafting iterations (e.g., 302). In various aspects, a drafting iteration (e.g., 302(j)) can comprise: querying, by the client device (e.g., via 206), a user (e.g., 110) for a respective one of the set of input prompts (e.g., 402(j)), which can be an edited version of a previous input prompt that was provided by the user during a previous drafting iteration. In various instances, the drafting iteration can further comprise: synthesizing, by the client device (e.g., via 206), a respective one of the set of coarse outputs (e.g., 404(j)), by executing, on the respective one of the set of input prompts, a first generative artificial intelligence model (e.g., 104) that is hosted by the client device.

In various cases, act 2104 can include instructing, by the client device (e.g., via 208), a server device (e.g., 106) to synthesize a fine output (e.g., 1002) by executing, on at least part of the prompt-output history, a second generative artificial intelligence model (e.g., 108) hosted by the server device. In various aspects, the first generative artificial intelligence model can exhibit lower fidelity but quicker inferencing time than the second generative artificial intelligence model.

Although not explicitly shown in FIG. 21, the computer-implemented method 2100 can comprise: receiving, by the client device (e.g., via 208), the fine output from the server device; and rendering, by the client device (e.g., via 208), the fine output on an electronic display.

Although not explicitly shown in FIG. 21, the prompt-output history can comprise a set of feedback indicators (e.g., 406), and the drafting iteration can further comprise: rendering, by the client device (e.g., via 206), the respective one of the set of coarse outputs on the electronic display; and querying, by the client device (e.g., via 206), the user for a respective one of the set of feedback indicators (e.g., 406(j)). In various cases, that respective one of the set of feedback indicators can specify whether the user approves or disapproves of the respective one of the set of coarse outputs.

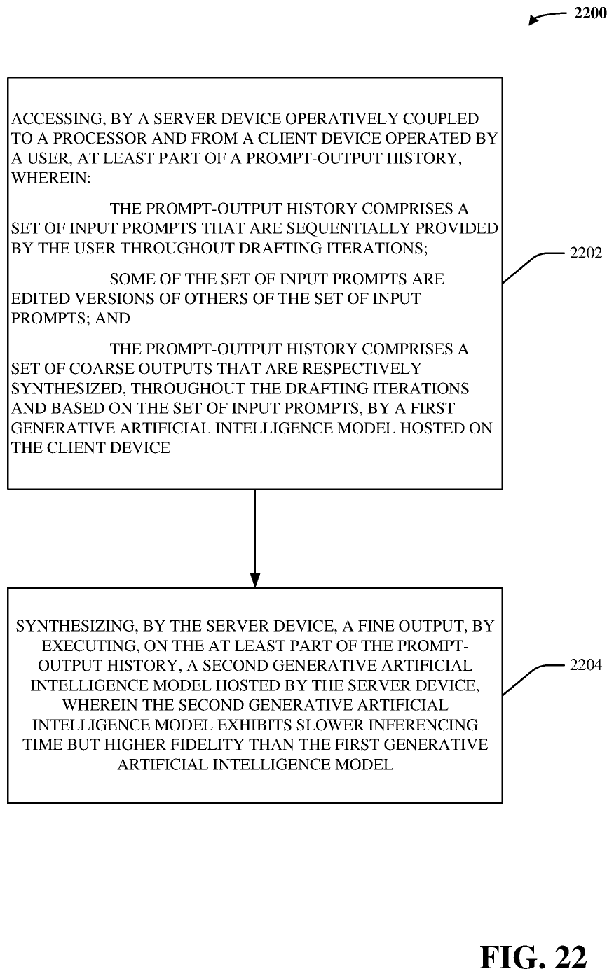

FIG. 22 illustrates a flow diagram of an example, non-limiting computer-implemented method 2200 that can facilitate server-side distributed generative artificial intelligence for improved user workflow in accordance with one or more embodiments described herein. In various cases, the server device 106 can facilitate the computer-implemented method 2200.

In various embodiments, act 2202 can include accessing, by a server device (e.g., via 806 of 106) operatively coupled to a processor (e.g., 802) and from a client device (e.g., 102) operated by a user (e.g., 110), at least part of a prompt-output history (e.g., 304). In various aspects, the prompt-output history can comprise a set of input prompts (e.g., 402) that are sequentially provided by the user throughout a set of drafting iterations (e.g., 302). In various instances, some of the set of input prompts can be edited versions of others of the set of input prompts. In various cases, the prompt-output history can comprise a set of coarse outputs (e.g., 404) that are respectively synthesized, throughout the set of drafting iterations and based on the set of input prompts, by a first generative artificial intelligence model (e.g., 104) hosted on the client device.

In various aspects, act 2204 can include synthesizing, by the server device (e.g., via 808), a fine output (e.g., 1002), by executing, on the at least part of the prompt-output history, a second generative artificial intelligence model (e.g., 108) hosted by the server device. In various cases, the second generative artificial intelligence model can exhibit slower inferencing time but higher fidelity than the first generative artificial intelligence model.

Although not explicitly shown in FIG. 22, the computer-implemented method 2200 can comprise: transmitting, by the server device (e.g., via 808), the fine output to the client device.

Although not explicitly shown in FIG. 22, the prompt-output history can comprise a set of feedback indicators (e.g., 406) that can specify whether the user approved or disapproved of respective ones of the set of coarse outputs.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f (z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For case of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

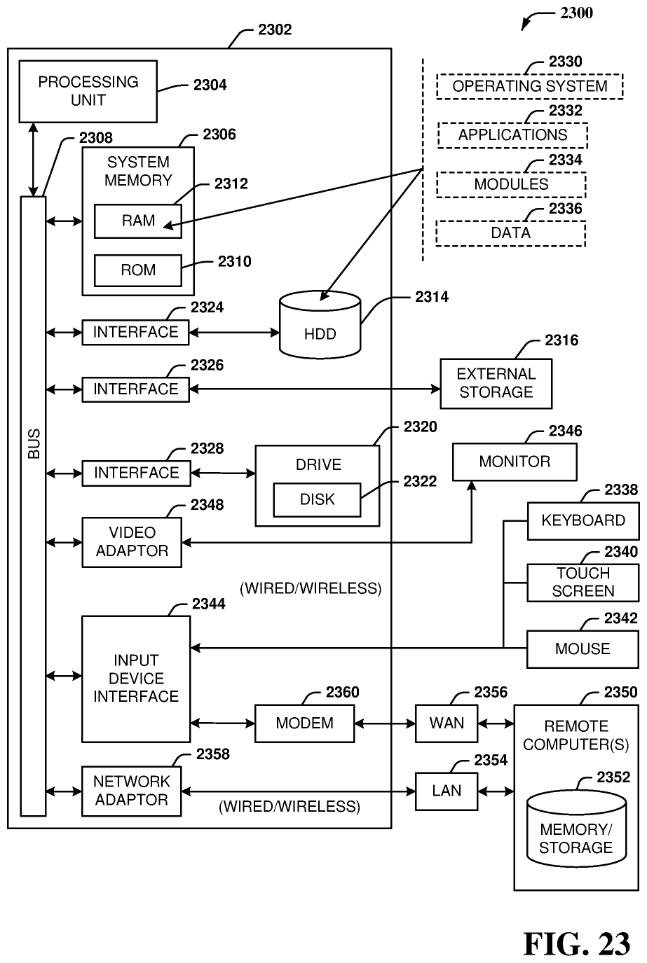

In order to provide additional context for various embodiments described herein, FIG. 23 and the following discussion are intended to provide a brief, general description of a suitable computing environment 2300 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 23, the example environment 2300 for implementing various embodiments of the aspects described herein includes a computer 2302, the computer 2302 including a processing unit 2304, a system memory 2306 and a system bus 2308. The system bus 2308 couples system components including, but not limited to, the system memory 2306 to the processing unit 2304. The processing unit 2304 can be any of various commercially available processors. Dual microprocessors and other multi-processor architectures can also be employed as the processing unit 2304.

The system bus 2308 can be any of several types of bus structure that can further interconnect to a memory bus (with or without a memory controller), a peripheral bus, and a local bus using any of a variety of commercially available bus architectures. The system memory 2306 includes ROM 2310 and RAM 2312. A basic input/output system (BIOS) can be stored in a non-volatile memory such as ROM, erasable programmable read only memory (EPROM), EEPROM, which BIOS contains the basic routines that help to transfer information between elements within the computer 2302, such as during startup. The RAM 2312 can also include a high-speed RAM such as static RAM for caching data.

The computer 2302 further includes an internal hard disk drive (HDD) 2314 (e.g., EIDE, SATA), one or more external storage devices 2316 (e.g., a magnetic floppy disk drive (FDD) 2316, a memory stick or flash drive reader, a memory card reader, etc.) and a drive 2320, e.g., such as a solid state drive, an optical disk drive, which can read or write from a disk 2322, such as a CD-ROM disc, a DVD, a BD, etc. Alternatively, where a solid state drive is involved, disk 2322 would not be included, unless separate. While the internal HDD 2314 is illustrated as located within the computer 2302, the internal HDD 2314 can also be configured for external use in a suitable chassis (not shown). Additionally, while not shown in environment 2300, a solid state drive (SSD) could be used in addition to, or in place of, an HDD 2314. The HDD 2314, external storage device(s) 2316 and drive 2320 can be connected to the system bus 2308 by an HDD interface 2324, an external storage interface 2326 and a drive interface 2328, respectively. The interface 2324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2312, including an operating system 2330, one or more application programs 2332, other program modules 2334 and program data 2336. All or portions of the operating system, applications, modules, or data can also be cached in the RAM 2312. The systems and methods described herein can be implemented utilizing various commercially available operating systems or combinations of operating systems.

Computer 2302 can optionally comprise emulation technologies. For example, a hypervisor (not shown) or other intermediary can emulate a hardware environment for operating system 2330, and the emulated hardware can optionally be different from the hardware illustrated in FIG. 23. In such an embodiment, operating system 2330 can comprise one virtual machine (VM) of multiple VMs hosted at computer 2302. Furthermore, operating system 2330 can provide runtime environments, such as the Java runtime environment or the .NET framework, for applications 2332. Runtime environments are consistent execution environments that allow applications 2332 to run on any operating system that includes the runtime environment. Similarly, operating system 2330 can support containers, and applications 2332 can be in the form of containers, which are lightweight, standalone, executable packages of software that include, e.g., code, runtime, system tools, system libraries and settings for an application.

Further, computer 2302 can be enable with a security module, such as a trusted processing module (TPM). For instance with a TPM, boot components hash next in time boot components, and wait for a match of results to secured values, before loading a next boot component. This process can take place at any layer in the code execution stack of computer 2302, e.g., applied at the application execution level or at the operating system (OS) kernel level, thereby enabling security at any level of code execution.

A user can enter commands and information into the computer 2302 through one or more wired/wireless input devices, e.g., a keyboard 2338, a touch screen 2340, and a pointing device, such as a mouse 2342. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2304 through an input device interface 2344 that can be coupled to the system bus 2308, but can be connected by other interfaces, such as a parallel port, an IEEE 1394 serial port, a game port, a USB port, an IR interface, a BLUETOOTH® interface, etc.

A monitor 2346 or other type of display device can be also connected to the system bus 2308 via an interface, such as a video adapter 2348. In addition to the monitor 2346, a computer typically includes other peripheral output devices (not shown), such as speakers, printers, etc.

The computer 2302 can operate in a networked environment using logical connections via wired or wireless communications to one or more remote computers, such as a remote computer(s) 2350. The remote computer(s) 2350 can be a workstation, a server computer, a router, a personal computer, portable computer, microprocessor-based entertainment appliance, a peer device or other common network node, and typically includes many or all of the elements described relative to the computer 2302, although, for purposes of brevity, only a memory/storage device 2352 is illustrated. The logical connections depicted include wired/wireless connectivity to a local area network (LAN) 2354 or larger networks, e.g., a wide area network (WAN) 2356. Such LAN and WAN networking environments are commonplace in offices and companies, and facilitate enterprise-wide computer networks, such as intranets, all of which can connect to a global communications network, e.g., the Internet.

When used in a LAN networking environment, the computer 2302 can be connected to the local network 2354 through a wired or wireless communication network interface or adapter 2358. The adapter 2358 can facilitate wired or wireless communication to the LAN 2354, which can also include a wireless access point (AP) disposed thereon for communicating with the adapter 2358 in a wireless mode.

When used in a WAN networking environment, the computer 2302 can include a modem 2360 or can be connected to a communications server on the WAN 2356 via other means for establishing communications over the WAN 2356, such as by way of the Internet. The modem 2360, which can be internal or external and a wired or wireless device, can be connected to the system bus 2308 via the input device interface 2344. In a networked environment, program modules depicted relative to the computer 2302 or portions thereof, can be stored in the remote memory/storage device 2352. It will be appreciated that the network connections shown are example and other means of establishing a communications link between the computers can be used.

When used in either a LAN or WAN networking environment, the computer 2302 can access cloud storage systems or other network-based storage systems in addition to, or in place of, external storage devices 2316 as described above, such as but not limited to a network virtual machine providing one or more aspects of storage or processing of information. Generally, a connection between the computer 2302 and a cloud storage system can be established over a LAN 2354 or WAN 2356 e.g., by the adapter 2358 or modem 2360, respectively. Upon connecting the computer 2302 to an associated cloud storage system, the external storage interface 2326 can, with the aid of the adapter 2358 or modem 2360, manage storage provided by the cloud storage system as it would other types of external storage. For instance, the external storage interface 2326 can be configured to provide access to cloud storage sources as if those sources were physically connected to the computer 2302.

The computer 2302 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

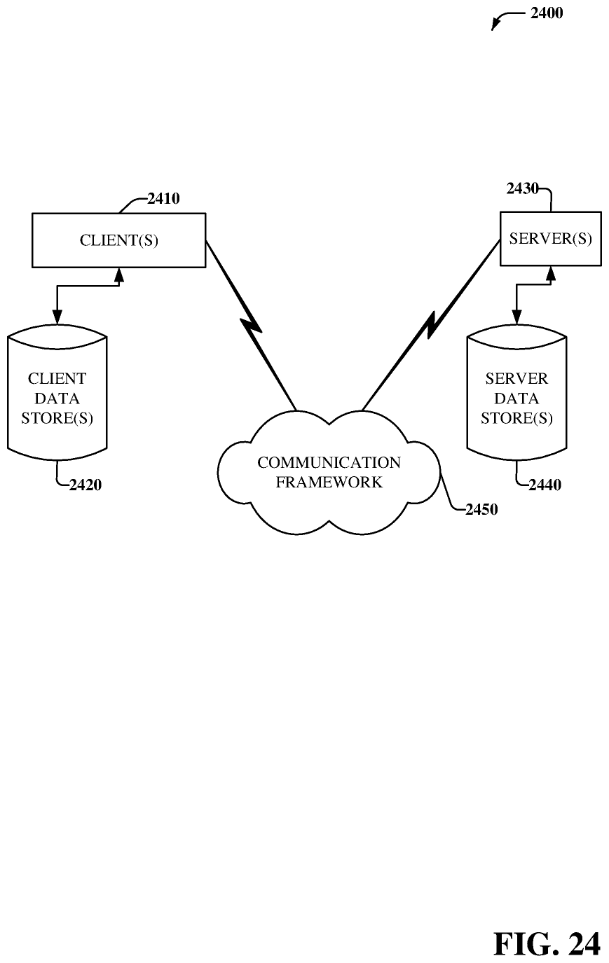

FIG. 24 is a schematic block diagram of a sample computing environment 2400 with which the disclosed subject matter can interact. The sample computing environment 2400 includes one or more client(s) 2410. The client(s) 2410 can be hardware or software (e.g., threads, processes, computing devices). The sample computing environment 2400 also includes one or more server(s) 2430. The server(s) 2430 can also be hardware or software (e.g., threads, processes, computing devices). The servers 2430 can house threads to perform transformations by employing one or more embodiments as described herein, for example. One possible communication between a client 2410 and a server 2430 can be in the form of a data packet adapted to be transmitted between two or more computer processes. The sample computing environment 2400 includes a communication framework 2450 that can be employed to facilitate communications between the client(s) 2410 and the server(s) 2430. The client(s) 2410 are operably connected to one or more client data store(s) 2420 that can be employed to store information local to the client(s) 2410. Similarly, the server(s) 2430 are operably connected to one or more server data store(s) 2440 that can be employed to store information local to the servers 2430.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.”

Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A client device, comprising:
a processor that executes computer-executable components stored in a non-transitory computer-readable memory, wherein the computer-executable components comprise:
a drafting component that generates a prompt-output history comprising a set of input prompts and a set of coarse outputs, by sequentially performing a set of drafting iterations, wherein, during a drafting iteration, the drafting component:
queries a user of the client device for a respective one of the set of input prompts, which is an edited version of a previous input prompt that was provided by the user during a previous drafting iteration; and
synthesizes a respective one of the set of coarse outputs, by executing, on the respective one of the set of input prompts, a first generative artificial intelligence model that is hosted by the client device; and
a finalization component that instructs a server device to synthesize a fine output by executing, on at least part of the prompt-output history, a second generative artificial intelligence model hosted by the server device, wherein the first generative artificial intelligence model exhibits lower fidelity but quicker inferencing time than the second generative artificial intelligence model.

2. The client device of claim 1, wherein the finalization component receives the fine output from the server device and renders the fine output on an electronic display.

3. The client device of claim 2, wherein the prompt-output history comprises a set of feedback indicators, and wherein, during the drafting iteration, the drafting component:
renders the respective one of the set of coarse outputs on the electronic display; and
queries the user for a respective one of the set of feedback indicators, which specifies whether the user approves or disapproves of the respective one of the set of coarse outputs.

4. The client device of claim 3, wherein the second generative artificial intelligence model causes the fine output to exhibit increased similarity with approved coarse outputs and to exhibit decreased similarity with disapproved coarse outputs.

5. The client device of claim 1, wherein:
the respective one of the set of input prompts comprises a textual description typed into the client device;
the respective one of the set of coarse outputs comprises a less-detailed image or video relating to the textual description, wherein the less-detailed image or video is colorless, is shading-less, is composed of shapes having outlines but no interior detail, has an empty background, or is below a threshold resolution or frame rate; and
the fine output comprises a more-detailed image or video relating to the textual description, wherein the more-detailed image or video has color, has shading, is composed of shapes having outlines and interior detail, has a non-empty background, or is above the threshold resolution or frame rate.

6. The client device of claim 5, wherein the respective one of the set of input prompts further comprises an augmented reality filtered image or video accessed by the client device.

7. The client device of claim 1, wherein the finalization component instructs the server device to produce the fine output based on metadata pertaining to the client device, wherein the metadata comprises a timestamp associated with the prompt-output history, a geostamp associated with the prompt-output history, or a modality type of the client device.

8. The client device of claim 1, wherein, during the drafting iteration, the drafting component suggests the respective one of the set of input prompts to the user, based on past drafting activity of the user or of other users.

9. A server device, comprising:
a processor that executes computer-executable components stored in a non-transitory computer-readable memory, wherein the computer-executable components comprise:
an access component that accesses, from a client device operated by a user, at least part of a prompt-output history, wherein:
the prompt-output history comprises a set of input prompts that are sequentially provided by the user throughout a set of drafting iterations;
some of the set of input prompts are edited versions of others of the set of input prompts; and
the prompt-output history comprises a set of coarse outputs that are respectively synthesized, throughout the set of drafting iterations and based on the set of input prompts, by a first generative artificial intelligence model hosted on the client device; and
a model component that synthesizes a fine output, by executing, on the at least part of the prompt-output history, a second generative artificial intelligence model hosted by the server device, wherein the second generative artificial intelligence model exhibits slower inferencing time but higher fidelity than the first generative artificial intelligence model.

10. The server device of claim 9, wherein the model component transmits the fine output to the client device.

11. The server device of claim 10, wherein the prompt-output history comprises a set of feedback indicators that specify whether the user approved or disapproved of respective ones of the set of coarse outputs.

12. The server device of claim 11, wherein the second generative artificial intelligence model causes the fine output to exhibit increased similarity with approved coarse outputs and to exhibit decreased similarity with disapproved coarse outputs.

13. The server device of claim 9, wherein:
a first input prompt of the set of input prompts comprises a textual description typed into the client device;
a first coarse output of the set of coarse outputs comprises a less-detailed image or video relating to the textual description, wherein the less-detailed image or video is colorless, is shading-less, is composed of shapes having outlines but no interior detail, has an empty background, or is below a threshold resolution or frame rate; and
the fine output comprises a more-detailed image or video relating to the textual description, wherein the more-detailed image or video has color, has shading, is composed of shapes having outlines and interior detail, has a non-empty background, or is above the threshold resolution or frame rate.

14. The server device of claim 13, wherein the first input prompt further comprises an augmented reality filtered image or video accessed by the client device.

15. The server device of claim 9, wherein the second generative artificial intelligence model synthesizes the fine output based on metadata pertaining to the client device, wherein the metadata comprises a timestamp associated with the prompt-output history, a geostamp associated with the prompt-output history, or a modality type of the client device.

16. A computer-implemented method, comprising:
generating, by a client device operatively coupled to a processor, a prompt-output history comprising a set of input prompts and a set of coarse outputs, by sequentially performing a set of drafting iterations, wherein a drafting iteration comprises:
querying, by the client device, a user for a respective one of the set of input prompts, which is an edited version of a previous input prompt that was provided by the user during a previous drafting iteration; and
synthesizing, by the client device, a respective one of the set of coarse outputs, by executing, on the respective one of the set of input prompts, a first generative artificial intelligence model that is hosted by the client device; and
instructing, by the client device, a server device to synthesize a fine output by executing, on at least part of the prompt-output history, a second generative artificial intelligence model hosted by the server device, wherein the first generative artificial intelligence model exhibits lower fidelity but quicker inferencing time than the second generative artificial intelligence model.

17. The computer-implemented method of claim 16, further comprising:
receiving, by the client device, the fine output from the server device; and
rendering, by the client device, the fine output on an electronic display.

18. The computer-implemented method of claim 17, wherein the prompt-output history comprises a set of feedback indicators, and wherein the drafting iteration further comprises:
rendering, by the client device, the respective one of the set of coarse outputs on the electronic display; and
querying, by the client device, the user for a respective one of the set of feedback indicators, which specifies whether the user approves or disapproves of the respective one of the set of coarse outputs.

19. The computer-implemented method of claim 18, wherein the second generative artificial intelligence model causes the fine output to exhibit increased similarity with approved coarse outputs and to exhibit decreased similarity with disapproved coarse outputs.

20. The computer-implemented method of claim 16, wherein:
the respective one of the set of input prompts comprises a textual description typed into the client device;
the respective one of the set of coarse outputs comprises a less-detailed image or video relating to the textual description, wherein the less-detailed image or video is colorless, is shading-less, is composed of shapes having outlines but no interior detail, has an empty background, or is below a threshold resolution or frame rate; and
the fine output comprises a more-detailed image or video relating to the textual description, wherein the more-detailed image or video has color, has shading, is composed of shapes having outlines and interior detail, has a non-empty background, or is above the threshold resolution or frame rate.
